(19) United States
(12) Patent Application Publication
(10) Pub. No.: US 2016/0203105 A1
(43) Pub. Date: Jul. 14, 2016

(54) INFORMATION PROCESSING DEVICE, INFORMATION PROCESSING METHOD, AND INFORMATION PROCESSING PROGRAM

(71) Applicant: FUJITSU LIMITED, Kawasaki-shi (JP)

(72) Inventor: Makoto NAKANISHI, Tagata (JP)

(21) Appl. No.: 14/958,247

(22) Filed: Dec. 3, 2015

(30) Foreign Application Priority Data
Jan. 8, 2015 (JP) 2015-002107

(51) Int. Cl. G06F 17/16

(52) U.S. Cl. CPC G06F 17/16

(57) ABSTRACT

An information processing method including processes of; generating from a complex asymmetric sparse matrix an elimination tree of a symmetric matrix of the complex asymmetric sparse matrix; based on the generated elimination tree, extracting a row subtree of each of rows of a lower triangular matrix of the complex asymmetric sparse matrix and a row subtree of each of rows of a transposed matrix of an upper triangular matrix of the complex asymmetric sparse matrix; and determining an amount of memory area to store a result of LU factorization of the complex asymmetric sparse matrix, based on the number of row subtrees including nodes of the elimination tree, of the extracted row subtrees of the rows of the lower triangular matrix, and the number of row subtrees including nodes of the elimination tree, of the extracted row subtrees of the rows of the transposed matrix of the upper triangular matrix.

### CROSS-REFERENCE TO RELATED APPLICATION

This application is based upon and claims the benefit of priority of the prior Japanese Patent Application No. 2015-002107, filed on Jan. 8, 2015, the entire contents of which are incorporated herein by reference.

### FIELD

The embodiments discussed herein are related to an information processing device, an information processing method, and an information processing program.

### BACKGROUND

Conventionally, as one of a direct solution of simultaneous linear equations, there is a method of finding the solution of simultaneous linear equations through LU factorization of a complex asymmetric sparse matrix, which is a coefficient matrix of the simultaneous linear equations. Related techniques include, for example, a technique to provide an iterative solution with preprocessing which provides highly effective acceleration by the preprocessing, as a solution of simultaneous linear equations. In addition, for example, there is a technique to obtain with an adequate amount of calculations a converged solution of a total system of equations formed of a main equation and a constraint equation. In addition, for example, there is a technique to efficiently process in parallel a product of a sparse matrix and a vector, using the compressed column storage method. In addition, for example, as the solution of simultaneous linear equations, there is a technique to perform preprocessing at a high speed on a parallel computer having a vector operation capability, in a Krylov subspace approach with the incomplete LU factorization preprocessing. In addition, for example, there is a technique to store only non-zero components for each column out of components of a sparse matrix.

Examples of the related conventional techniques are disclosed for example in Japanese Laid-open Patent Publication Nos. 2011-145999, 2005-115497, 2009-199430, 2007-133710, and 2010-122850.

In the conventional techniques described above, however, in some cases, when LU factorizing a complex asymmetric sparse matrix, even areas which do not have to be reserved may be reserved as an area where a result of the LU factorization of the complex asymmetric sparse matrix is stored. In this case, an amount of memory used in the LU factorization of the complex asymmetric sparse matrix increases, and the processing efficiency decreases due to operation which do not have to be performed.

In one aspect, the embodiments are intended to provide an information processing device, an information processing method, and an information processing program that efficiently performs LU factorization of a complex asymmetric sparse matrix.

### SUMMARY

According to an aspect of the invention, an information processing device including: a control unit configured to generate from a complex asymmetric sparse matrix an elimination tree of a symmetric matrix of the complex asymmetric sparse matrix, based on the generated elimination tree, extract a row subtree of each of rows of a lower triangular matrix of the complex asymmetric sparse matrix and a row subtree of each of rows of a transposed matrix of an upper triangular matrix of the complex asymmetric sparse matrix, and determine an amount of memory area to store a result of LU factorization of the complex asymmetric sparse matrix, based on the number of row subtrees including nodes of the elimination tree, of the extracted row subtrees of the rows of the lower triangular matrix, and the number of row subtrees including nodes of the elimination tree, of the extracted row subtrees of the rows of the transposed matrix of the upper triangular matrix.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating one example of a pattern of non-zero elements of a sparse matrix A to be LU factorized;

FIG. 2 is an explanatory diagram illustrating one example of a pattern of non-zero elements of a lower triangular matrix L(P) and a transposed matrix L(P)̂T of the lower triangular matrix L(P);

FIG. 3 is an explanatory diagram illustrating an elimination tree;

FIG. 4 is an explanatory diagram illustrating one example of an approximated pattern of non-zero elements of a lower triangular matrix L(A) and an upper triangular matrix U(A);

FIG. 5 is an explanatory diagram illustrating another example of a pattern of non-zero elements of the sparse matrix A to be LU factorized;

FIG. 6 is an explanatory diagram illustrating another example of a pattern of the non-zero elements of the lower triangular matrix L(P) and the transposed matrix L(P)̂T of the lower triangular matrix L(P);

FIG. 7 is an explanatory diagram illustrating an elimination tree;

FIG. 8 is an explanatory diagram illustrating another example of the approximated pattern of the non-zero elements of the lower triangular matrix L(A) and the upper triangular matrix U(A);

FIG. 9 is a block diagram illustrating one example of hardware of an information processing device according to an embodiment;

FIG. 10 is a block diagram illustrating a functional configuration example of the information processing device;

FIG. 11 is an explanatory diagram illustrating a pattern of non-zero elements of a lower triangular matrix C(A) and an upper triangular matrix R(A);

FIG. 12 is an explanatory diagram illustrating a pattern of non-zero elements of the lower triangular matrix C(P);

FIG. 13 is an explanatory diagram illustrating a pattern of non-zero elements of the lower triangular matrix L(P);

FIG. 14 is an explanatory diagram illustrating an elimination tree;

FIG. 15 is an explanatory diagram illustrating one example of a subtree which expresses non-zero elements on the 7^{th} row;

FIG. 16 is an explanatory diagram illustrating one example of a subtree which expresses non-zero elements on the 11^{th} row;

FIG. 17 is an explanatory diagram illustrating one example of the compressed column storage method;

FIG. 18 is a flow chart illustrating one example of a calculation procedure according to an example 1;

FIG. 19 is a flow chart illustrating one example of a calculation procedure according to an example 2;

FIG. 20 is a flow chart illustrating one example of a counting procedure of column count;

FIG. 21 is a flow chart illustrating one example of the counting procedure of column count; and

FIG. 22 is a flow chart illustrating one example of the counting procedure of column count.

### DESCRIPTION OF EMBODIMENTS

An embodiment of an information processing device, an information processing method, and an information processing program according to the present disclosure is described in detail hereinafter, with reference to the drawings.

(Example of an Information Processing Method)

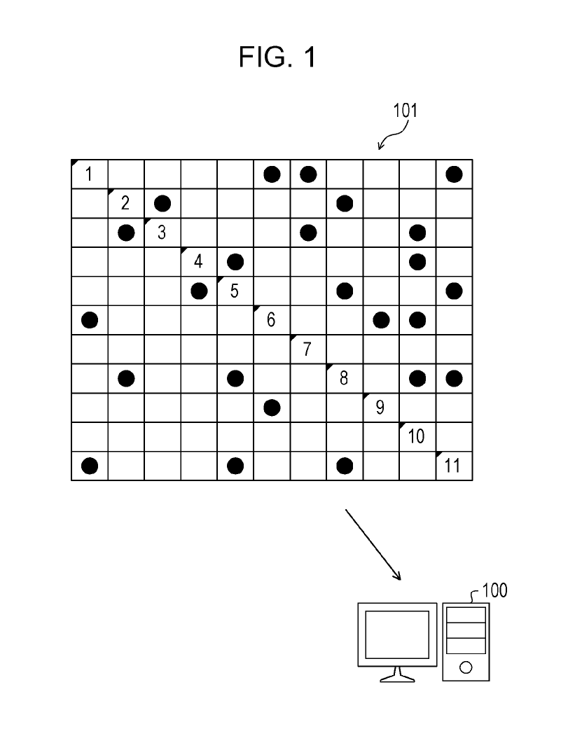

First, with reference to FIGS. 1 to 4, an example of an information processing method according to this embodiment is described. In FIG. 1, an information processing device 100 is a computer configured to determine an amount of memory area where a result of LU factorization of a complex asymmetric sparse matrix A is stored.

A sparse matrix is a matrix including a number of elements that are zero as a matrix element. A complex asymmetric sparse matrix is a matrix that does not match a transposed matrix of the complex sparse matrix. LU factorization is the expression of a matrix by a product of a lower triangular matrix L and an upper triangular matrix U. A lower triangular matrix is a matrix in which elements located above diagonal elements are all zeros. Diagonal elements are elements located at positions where a row number and a column number match. An upper triangular matrix is a matrix in which elements located below the diagonal elements are all zero. In the description below, an element that is zero may be described as a “zero element”. In addition, in the description below, an element that is not zero may be described as a “non-zero element”.

It is conceivable that, as an area to store a result of LU factorization of a complex asymmetric sparse matrix A, an area is reserved to store a result of LL̂T factorization of a symmetric matrix P, which is a sum of the complex asymmetric sparse matrix A and a transposed matrix ÂT of the complex asymmetric sparse matrix A. In this case, for example, an arithmetic unit is configured to generate an elimination tree that indicates a dependence relationship between the columns when LL̂T factorizing the symmetric matrix P and calculate an area to store a result of the LL̂T factorization of the symmetric matrix P.

LL̂T factorization is one form of LU factorization. LL̂T factorization means expressing a symmetric matrix with a lower triangular matrix L and a transposed matrix L̂T of the lower triangular matrix L. The LL̂T factorization is also referred to as Cholesky factorization. An elimination tree is a tree that indicates a dependence relationship between the columns of the symmetric matrix P. The elimination tree is a tree including nodes related to the columns. In the description below, a node related to the j^{th} column may be denoted by “node[j]”. In addition, in the description below, “j” in the node[j] may be described as an “index”.

In this case, however, an area to store a result of the LU factorization of the complex asymmetric sparse matrix A also includes an area to store zero elements that do not have to be stored. More specifically, as a complex asymmetric sparse matrix A increases in size, areas to be reserved run short, which may thus not enable LU factorization of the complex asymmetric sparse matrix A. In addition, the arithmetic unit performs arithmetic operation on zero elements which does not have to be performed in the LU factorization, resulting in increased processing time taken for the LU factorization.

In particular, there is a case in which when the degree of asymmetry of an asymmetric sparse matrix A increases, many of combinations of elements of the complex asymmetric sparse matrix A which are located at mutually symmetric positions may be a combination of non-zero element and zero element. In this case, in a symmetric matrix P generated from the complex asymmetric sparse matrix A, a non-zero element also appears at a position that corresponds to a position in the complex asymmetric sparse matrix A where a zero element is present. Thus, the non-zero element in the symmetric matrix P affects the result of the LL̂T factorization of the symmetric matrix P, which makes the number of non-zero elements included in the result of the LL̂T factorization of the symmetric matrix P larger than the number of non-zero elements included in the result of the LU factorization of the complex asymmetric sparse matrix A. Consequently, the area reserved based on the result of the LL̂T factorization of the symmetric matrix P where the result of the LU factorization of the complex asymmetric sparse matrix A is stored also includes an area to store zero elements that do not have to be stored.

Then, in the embodiment, an information processing method that may efficiently perform LU factorization of a complex asymmetric sparse matrix is described. According to this information processing method, it is possible to reduce the risk of reserving an area to store zero elements that do not have to be stored and to perform LU factorization of a complex asymmetric sparse matrix. In the description below, a complex asymmetric sparse matrix A may be simply referred to as a “sparse matrix A”.

First, the information processing device 100 acquires a sparse matrix A to be LU factorized. A sparse matrix to be LU factorized is, for example, a matrix of 11 rows and 11 columns. In the description below, an element located on the row i and the column j of the sparse matrix A may be denoted by an “element a[i,j]”. Here, one example of a pattern of non-zero elements of the sparse matrix A to be LU factorized is described, with reference to FIG. 1.

FIG. 1 is an explanatory diagram illustrating one example of a pattern of non-zero elements of a sparse matrix A to be LU factorized. The box of the i^{th} row and the j^{th} column of a grid 101 of FIG. 1 corresponds to the element of the i^{th} row and the j^{th} column of the sparse matrix A and indicates that the element of the i^{th} row and the j^{th} column of the sparse matrix A is any of a diagonal element, a zero element, and a non-zero element. For example, a diagonal element is represented by a “row number i (=column number j) of the sparse matrix A where the diagonal element is present”. In addition, a zero element is represented by a “blank”. In addition, a non-zero element is represented by a filled circle. As illustrated in FIG. 1, there is no non-zero element other than the diagonal elements on the 7^{th} and 10^{th} rows of the sparse matrix A.

Then, the information processing device 100 LL̂T factorizes a symmetric matrix P, which is obtained by symmetrizing the sparse matrix A and which is a sum of the sparse matrix A and the sparse matrix ÂT, and expresses the symmetric matrix P by a product of a lower triangular matrix L(P) and a transposed matrix L(P)̂T of the lower triangular matrix L(P).

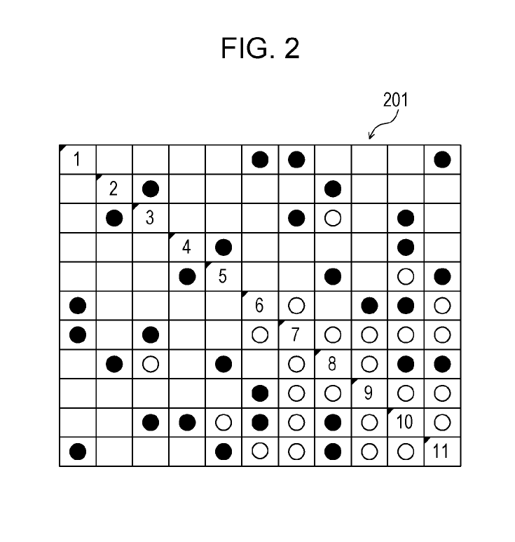

In the description below, in some cases, the element located at the i^{th} row and the j^{th} column of the lower triangular matrix L(P) may be denoted by an “element l[i,j]”. In addition, the element located at the i^{th} row and the j^{th} column of the transposed matrix L(P)̂T of the lower triangular matrix L(P) may be denoted by an “element lt[i,j]”. Here, one example of a pattern of non-zero elements of the lower triangular matrix L(P) and the transposed matrix L(P)̂T of the lower triangular matrix L(P), which is obtained by LL̂T factorizing the symmetric matrix P, is described with reference to FIG. 2.

FIG. 2 is an explanatory diagram illustrating one example of a pattern of non-zero elements of a lower triangular matrix L(P) and a transposed matrix L(P)̂T of the lower triangular matrix L(P). A grid 201 of FIG. 2 illustrates a pattern of non-zero elements of the lower triangular matrix L(P) by a lower triangular part divided by diagonal elements and a pattern of non-zero elements of the transposed matrix L(P)̂T of the lower triangular matrix L(P) by an upper triangular part divided by the diagonal elements.

The box of the i^{th} row and the j^{th} column of the grid 201 of FIG. 2 corresponds to the element on the i^{th} row and the j^{th} column of the lower triangular matrix L(P) when i>j, and indicates that the element of the i^{th} row and the j^{th} column of the lower triangular matrix L(P) is any of a diagonal element, a zero element, a non-zero element, and a fill-in. The fill-in is the element l[i,j] on the i^{th} row and the j^{th} column of the lower triangular matrix L(P), and becomes a non-zero element although the element p[i,j] on the i^{th} row and the j^{th} column which is located at the same position in the symmetric matrix P is a zero element. A fill-in is represented as an open circle, for example.

On the one hand, when i<j, the box of the i^{th} row and the j^{th} column of the grid 201 of FIG. 2 corresponds to the element on the i^{th} row and the j^{th} column of the transposed matrix L(P)̂T of the lower triangular matrix L(P) and indicates that the element on the i^{th} row and the j^{th} column of the transposed matrix L(P)̂T is any of a diagonal element, a zero element, a non-zero element, and a fill-in.

Here, a pattern of the non-zero elements of the symmetric matrix P includes a pattern of the non-zero elements of the sparse matrix A. Thus, a position where a non-zero element appears in the lower triangular matrix L(A) due to influence of the non-zero elements of the sparse matrix A matches a position where a non-zero element appears in the lower triangular matrix L(P) due to influence of the non-zero elements of the symmetric matrix P located at the same position as the non-zero elements of the sparse matrix A. Similarly, the position where a non-zero element appears in an upper triangular matrix U(A) matches a position where a non-zero element appears in the transposed matrix L(P)̂T.

On the one hand, in the symmetric matrix P, non-zero elements are also present at a corresponding position where zero-elements are present in the sparse matrix A. Thus, in the lower triangular matrix L(P), due to influence of the non-zero elements, non-zero elements appear even at a corresponding position where non-zero element does not appear in the lower triangular matrix L(A). Similarly, in the transposed matrix L(P)̂T, non-zero elements appear even at a corresponding position where non-zero elements do not appear in the upper triangular matrix U(A). Given these, a pattern of non-zero elements of the lower triangular matrix L(P) or the transposed matrix L(P)̂T obtained by LL̂T factorizing the symmetric matrix P includes a pattern of non-zero elements of the lower triangular matrix L(A) or the upper triangular matrix U(A) obtained by LU factorizing the sparse matrix A.

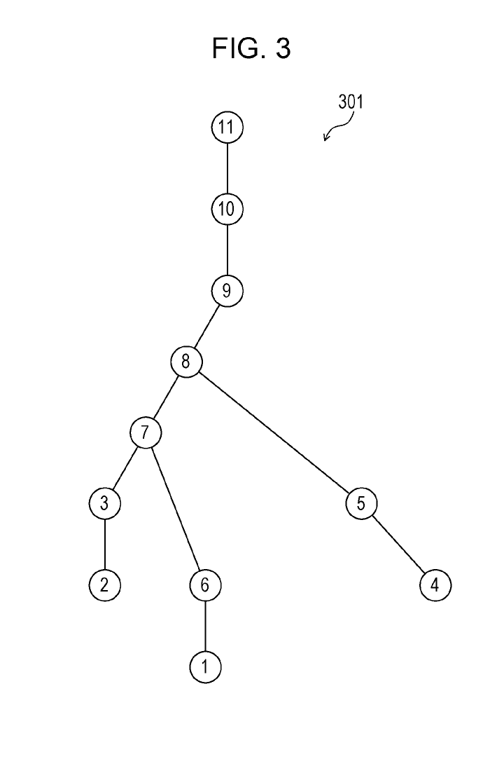

Next, the information processing device 100 generates an elimination tree of the symmetric matrix P based on a result of LL̂T factorization of the symmetric matrix P. Here, an elimination tree based on a pattern of non-zero elements of the lower triangular matrix L(P) or the transposed matrix L(P)̂T of the lower angular matrix L(P) as illustrated in FIG. 2 is described with reference to FIG. 3.

FIG. 3 is an explanatory diagram illustrating an elimination tree 301. When there are a node [i] and a node [j] where i>j, and if min{i|i>j and l[i,j]≠0} is satisfied, the information processing device 100 generates the elimination tree 301 with the node[i] as a parent node of the node[j]. If the node[i] is not an ancestor of the node[j] in the elimination tree 301, the element on the i^{th} column of the LL̂T factorized lower triangular matrix L(P) does not affect the calculation of the element on the i^{th} column of the LL̂T factorized lower triangular matrix L(P).

Here, although the case in which the information processing device 100 generates the elimination tree 301 based on the result of the LL̂T factorization of the symmetric matrix P has been described, a case is not limited to this. For example, the information processing device 100 may generate the elimination tree 301 based on the sparse matrix A without LL̂T factorizing the symmetric matrix P, or may generate the elimination tree 301 based on a lower triangular matrix C(P) of the symmetric matrix P before being LL̂T factorized. For details of the elimination tree 301, see T. A. Davis, Direct Methods for Sparse Linear Systems, SIAM, Philadelphia, 2006.

Then, the information processing device 100 specifies a pattern of non-zero elements of the lower triangular matrix L(A) and the upper triangular matrix U(A) obtained by LU factorizing the sparse matrix A based on the elimination tree 301. Here, a pattern of non-zero elements on the i^{th} row of the lower triangular matrix L(A) is approximated by a row subtree of the elimination tree 301 including as a root node a node related to a column having a diagonal element on the i^{th} row of the lower triangular matrix L(A). Similarly, a pattern of non-zero elements on i^{th} row of the transposed matrix U(A)̂T of the upper triangular matrix U(A) is approximated by a row subtree of the elimination tree 301 including as a root node a node related to a column having a diagonal element on i^{th} row of the transposed matrix U(A)̂T. In the description below, a row subtree may be described as a “subtree”.

Thus, the information processing device 100 specifies as a root node the node related to a column having the diagonal element on the i^{th} row of the lower triangular matrix C(A), and specifies as a leaf node a node related to a column having a non-zero element other than the diagonal element. Then, the information processing device 100 approximates the pattern of the non-zero elements on the i^{th} row of the lower triangular matrix L(A) by a subtree of the elimination tree 301 including the specified root and leaf nodes. Then, the information processing device 100 calculates the number of non-zero elements present on each column of the lower triangular matrix L(A), based on a pattern of non-zero elements of each row of the lower triangular matrix L(A).

Similarly, the information processing device 100 specifies as a root node a node related to a column having a diagonal element on the i^{th} row of the transposed matrix R(A)̂T of the upper triangular matrix R(A), and specifies as a leaf node a node related to a column having non-zero elements other than the diagonal element. Then, the information processing device 100 approximates a pattern of non-zero elements on the i^{th} row of the transposed matrix U(A)̂T of the upper triangular matrix U(A) by a subtree of the elimination tree 301 including the specified root and leaf nodes. Then, the information processing device 100 calculates the number of non-zero elements present in each column of the transposed matrix U(A)̂T, based on a pattern of non-zero elements on each row of the transposed matrix U(A)̂T.

The information processing device 100 determines from the pattern of non-zero elements on the 7^{th} row of the lower triangular matrix C(A) of the sparse matrix C(A) of FIG. 1, for example, that there is no leaf node on the 7^{th} row of the LU factorized lower triangular matrix L(A). Then, the information processing device 100 approximates a pattern of non-zero elements on the 7^{th} row of the lower triangular matrix L(A) by a subtree including a node[7].

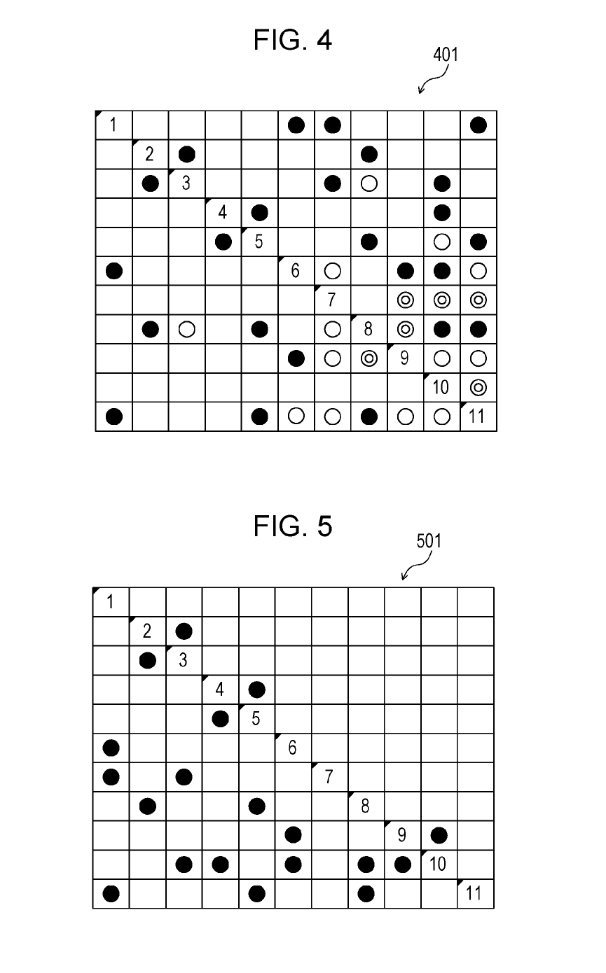

The information processing device 100 also determines from a pattern of non-zero elements on the 10^{th} row of the lower triangular matrix C(A) of the sparse matrix A of FIG. 1 that there is no leaf node on the 10^{th} row of the lower triangular matrix L(A). Then, the information processing device 100 approximates a pattern of non-zero elements on the 10^{th} row of the lower triangular matrix L(A) by a subtree including a node[10]. Here, one example of an approximated pattern of non-zero elements of the lower triangular matrix L(A) and the upper triangular matrix U(A) which are obtained by LU factorizing the sparse matrix A with reference to FIG. 4.

FIG. 4 is an explanatory diagram illustrating one example of an approximated pattern of non-zero elements of the lower triangular matrix L(A) and the upper triangular matrix U(A). In a grid 401 of FIG. 4, an approximated pattern of non-zero elements of the lower triangular matrix L(A) is represented by a lower triangular part divided by diagonal elements, and an approximated pattern of non-zero elements of the upper triangular matrix U(A) is represented by an upper triangular part divided by the diagonal elements.

The box on the i^{th} row and the j^{th} column of the grid 401 of FIG. 4 corresponds to the element on the i^{th} row and the j^{th} column of the lower triangular matrix L(A) when i>j, and indicates that the element on the i^{th} row and the j^{th} column of the lower triangular matrix L(A) is any of a diagonal element, a zero element, a non-zero element, a fill-in, and a false fill-in. A false fill-in is an element that becomes a fill-in because the false fill-in approximates a pattern of non-zero elements, although the false fill-in does not actually become a fill-in. For example, a false fill-in is represented by a double circle.

On the one hand, the box on the i^{th} row and the j^{th} column of the grid 401 of FIG. 4 corresponds to the element on i^{th} row and the j^{th} column of the upper triangular matrix U(A) when i<j and indicates that the element on i^{th} row and the j^{th} column of the upper triangular matrix U(A) is any of a diagonal element, a zero element, a non-zero element, a fill-in, and a false fill-in.

Here, in some cases, even if there is a non-zero element at a certain position of the symmetric matrix P, there may not be a non-zero element in the sparse matrix A. Thus, there is less influence of non-zero elements when a pattern of non-zero elements of the lower triangular matrix L(A) is approximated from a combination of the sparse matrix A and the elimination tree 301, rather than being approximated from a combination of the symmetric matrix P and the elimination tree 301. As a result, this reduces the risk of determining that an element which does not become a non-zero element in the actually LU factorized lower triangular matrix L(A) is a non-zero element, and similarly reduces the risk of determining that an element which does not become a non-zero element in the actually LU factorized upper triangular matrix U(A) is a non-zero element.

In other words, a pattern of non-zero elements of FIG. 4 is included in a pattern of non-zero elements illustrated in FIG. 2 for the case in which the symmetric matrix P is LL̂T factorized, and may have a fewer number of fill-ins than a pattern of non-zero elements for the case in which the symmetric matrix P is LL̂T factorized. In the example of FIG. 4, the number of fill-ins on the 7^{th} and 10^{th} rows in the pattern of the non-zero elements of FIG. 4 is smaller than the number of fill-ins on the 7^{th} and 10^{th} rows in the pattern of non-zero elements for the case in which the symmetric matrix P is LL̂T factorized.

In addition, since the elimination tree 301 is not a tree indicating a dependence relationship between the columns when LU factorizing the sparse matrix A, columns that have no dependence on each other may be considered columns that have dependence on each other, when actually LU factorizing the sparse matrix A. However, at least, the columns that have dependence on each other when actually LU factorizing the sparse matrix is indicated as columns having dependence on each other. Thus, a position of the lower triangular matrix L(A) where a non-zero element appears due to influence of non-zero elements of the sparse matrix A is determined at least as a position where a non-zero element appears. Similarly, a position of the upper triangular matrix U(A) where a non-zero element appears due to influence of non-zero elements of the sparse matrix A is determined at least as a position where a non-zero element appears.

In other words, while the pattern of the non-zero elements of FIG. 4 may have more fill-ins than the pattern of the non-zero elements for the case in which the sparse matrix A is LU factorized, the pattern of the non-zero elements of FIG. 4 includes at least the pattern of the non-zero elements for the case in which the sparse matrix A is LU factorized.

This enables the information processing device 100 to calculate a size of an area to store the lower triangular matrix L(A) with precision. The information processing device 100, for example, may calculate a size of an area which is smaller than an area based on a pattern of non-zero elements for the case in which the symmetric matrix P is LL̂T factorized and which may store the lower triangular matrix L(A) or the upper triangular matrix U(A) obtained by LU factorizing the sparse matrix A. As an area to store the lower triangular matrix L(A) and the upper triangular matrix U(A), the information processing device 100 specifically prepares an area to store indices of non-zero elements of each column of the lower triangular matrix L(A) and each row of the upper triangular matrix U(A), as well as an area to store non-zero elements.

In this manner, the information processing device 100 may reduce a size of an area to store a result of LU factorization, and store a result of LU factorization even if the sparse matrix A increases in size. For example, there is a case in which the degree of asymmetry of the sparse matrix A is high and there are non-zero elements only in the lower triangular matrix C(A). In this case, it is likely that the information processing device 100 may reduce the size of the area almost to half compared with a case in which the size of the area is calculated based on a pattern of non-zero elements for the case in which the symmetric matrix P is LL̂T factorized.

In addition, it is likely that the information processing device 100 may omit operation that does not have to be performed in LU factorization, and LU factorization may be performed efficiently. For example, there is a case in which the degree of asymmetry of the sparse matrix A is high and non-zero elements are present only in the lower triangular matrix C(A). In this case, it is likely that the information processing device 100 may reduce an amount of operation to almost half.

Here, the information processing device 100 reducing the amount of operation is described, taking a case of actual LU factorization as an example. When actually LU factorizing, the information processing device 100 performs depth first search of the elimination tree 301 and assigns post-order. Then, the information processing device 100 updates each column of the lower triangular matrix L(A) and each row of the upper triangular matrix U(A) by left looking and upward looking in the order of assigned post-order.

Left looking is to update an element on the column j of the lower triangular matrix L(A) by referring to an element of a column located to the left of the column j of the lower triangular matrix L(A), in LU factorization of the sparse matrix A. In addition, upward looking is to update an element on the row i of the upper triangular matrix U(A) by referring to an element on a row upper than the row i of the upper triangular matrix U(A), in the LU factorization of the sparse matrix A. In the description below, an element on the i^{th} row and the j^{th} column of the lower triangular matrix L(A) may be denoted by “la[i,j]”. In addition, in the description below, an element on the i^{th} row and the j^{th} column of the upper triangular matrix U(A) may be denoted by “ua[i,j]”.

For example, the information processing device 100 may update an element ua[7,j] on the 7^{th} row of the upper triangular matrix U(A). In this case, the information processing device 100 multiplies a non-zero element la[7,i] (i<7) on the 7^{th} row of the lower triangular matrix L(A) by an element ua[i,j] of the upper triangular matrix U(A) having as a row number the same value as a column number of the non-zero element and subtracts the product from a[7,j]. However, the information processing device 100 does not have to perform operation to update the 7^{th} row of the upper triangular matrix U(A) unless there is a non-zero element in the element la[7,i] (i<7) of the lower triangular matrix L(A).

Thus, the information processing device 100 may reduce the amount of operation during LU factorization by omitting the operation to update the 7^{th} row of the upper triangular matrix U(A) if the pattern of the non-zero elements of the lower triangular matrix L(A) is that of the example of FIG. 4. Specifically, the information processing device 100 determines whether or not an area is reserved for the 7^{th} row of the lower triangular matrix L(A), and omits the operation for the 7^{th} row of the upper triangular matrix U(A) if the area is not reserved since the 7^{th} row of the lower triangular matrix L(A) is a non-zero element.

Here, it is described how the information processing device 100 specifies a position where a non-zero element is located, in the above-mentioned operation. The information processing device 100 traces each node in the order of the assigned post-order when specifying the position where the non-zero element is located. Tracing each node in the order of the assigned post-order, for example, the information processing device 100 calculates a sum of a set of indices of child nodes of the node and a set of indices of non-zero elements of a column to be LU factorized according to the node. This enables the information processing device 100 to specify an index of a non-zero element of the lower triangular matrix L(A).

Similarly, the information processing device 100 traces each node in the order of the assigned post-order and calculates a sum of a set of indices of child nodes of the node and a set of indices of non-zero elements of a row to be LU factorized according to the node. This enables the information processing device 100 to specify an index of a non-zero element of the upper triangular matrix U(A).

Given these, with the information processing device 100, a size of an area to store a result of LU factorized sparse matrix A may be reduced. Then, since the information processing device 100 does not reserve an area to store zero elements that do not have to be reserved, the amount of processing involving LU factorization may be reduced and any increase in processing time may be avoided, which thus allows efficient LU factorization.

With this, when solving simultaneous linear equations using a complex asymmetric sparse matrix in analysis of an electromagnetic field, acoustics, quantum mechanics, a circuit or the like, a size of an area to store a result of LU factorization may be reduced to cope with the large-size problem.

(Other Examples of an Information Processing Method)

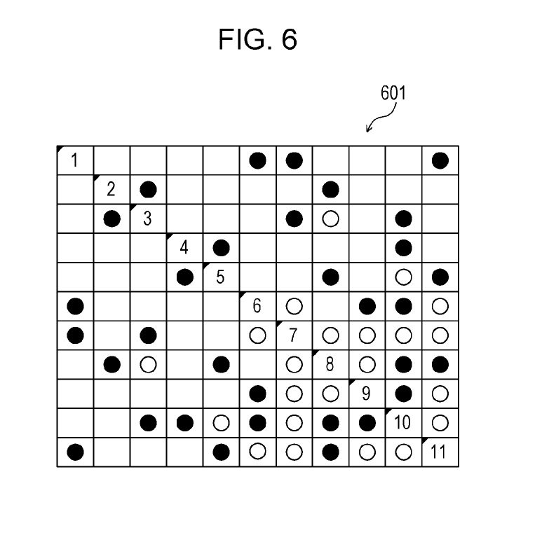

First, an information processing device 100 acquires a sparse matrix A to be LU factorized that has a pattern of non-zero elements which is different from the pattern of non-zero elements illustrated in FIG. 1. For example, a sparse matrix A to be LU factorized is a matrix of 11 rows and 11 columns. Here, another example of a pattern of non-zero elements of the sparse matrix A to be LU factorized is illustrated with reference to FIG. 5.

FIG. 5 is an explanatory diagram illustrating another example of a pattern of non-zero elements of a sparse matrix A to be LU factorized. The box of the i^{th} row and the j^{th} column of a grid 501 of FIG. 5 corresponds to the element of the i^{th} row and the j^{th} of a sparse matrix A, and indicates that the element of the i^{th} row and the j^{th} of the sparse matrix A is any of a diagonal element, a zero element, and a non-zero element. As illustrated in FIG. 5, the sparse matrix A has a high degree of asymmetry, and there are more non-zero elements in a lower triangular matrix C(A) than in an upper triangular matrix R(A).

Then, the information processing device 100 generates a symmetric matrix P which is obtained by symmetrizing the sparse matrix A, LL̂T factorizes the generated symmetric matrix P, and expresses the generated symmetric matrix P by a product of a lower triangular matrix L(P) and a transposed matrix L(P)̂T of the lower triangular matrix L(P). Here, another example of a pattern of non-zero elements of the lower triangular matrix L(P) and the transposed matrix L(P)̂T of the lower triangular matrix L(P) that is obtained by LL̂T factorizing the symmetric matrix P is described with reference to FIG. 6.

FIG. 6 is an explanatory diagram illustrating another example of a pattern of non-zero elements of the lower triangular matrix L(P) and the transposed matrix L(P)̂T of the lower triangular matrix L(P). In a grid 601 of FIG. 6, a pattern of non-zero elements of the lower triangular matrix L(P) is represented by a lower triangular part divided by diagonal elements, and a pattern of non-zero elements of the transposed matrix L(P)̂T of the lower triangular matrix L(P) is represented by an upper triangular part divided by the diagonal elements.

The box of the i^{th} row and the j^{th} column of the grid 601 of FIG. 6 corresponds to the element of the i^{th} row and the j^{th} column of the lower triangular matrix L(P) when i>j, and indicates that the element of the i^{th} row and the j^{th} column of the lower triangular matrix L(P) is any of a diagonal element, a zero element, a non-zero element, and a fill-in. On the one hand, the box on the i^{th} row and the j^{th} column of the grid 601 of FIG. 6 corresponds to the element of the i^{th} row and the j^{th} column of the transposed matrix L(P)̂T of the lower triangular matrix L(P) when i<j, and indicates that the element of the i^{th} row and the j^{th} column of the transposed matrix L(P)̂T is any of a diagonal element, a zero element, a non-zero element, and a fill-in.

Here, the pattern of non-zero elements of the lower triangular matrix L(P) or the transposed matrix L(P)̂T obtained by LL̂T factorizing the symmetric matrix P includes a pattern of non-zero elements of a lower triangular matrix L(A) or an upper triangular matrix U(A) obtained by LU factorizing the sparse matrix A.

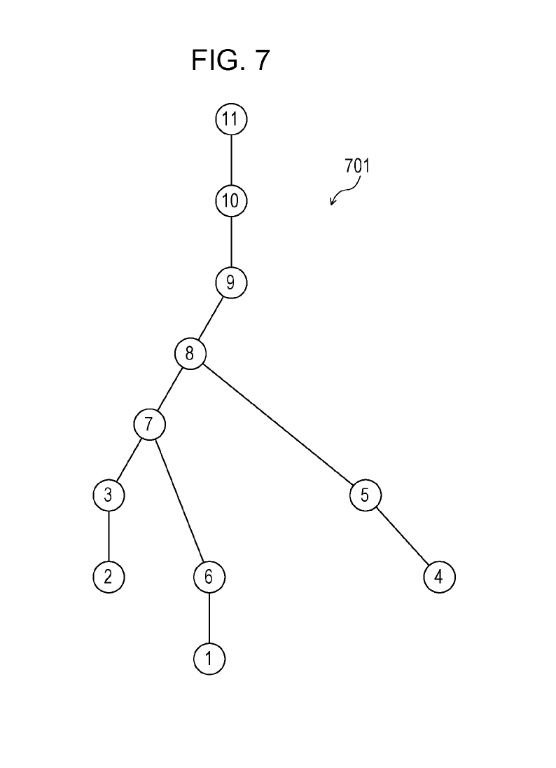

Then, the information processing device 100 generates an elimination tree 701 of the symmetric matrix P based on a result of the LL̂T factorized symmetric matrix P. Here, the elimination tree 701 based on the pattern of non-zero elements of the lower triangular matrix L(P) or the transposed matrix L(P)̂T of the lower triangular matrix L(P) as illustrated in FIG. 6 is described with reference to FIG. 7.

FIG. 7 is an explanatory diagram illustrating the elimination tree 701. When there are a node [i] and a node [j] where i>j, and if min{i|i>j and l[i,j]≠0} is satisfied, the information processing device 100 generates the elimination tree 701 with the node[i] as a parent node of the node[j].

Then, based on the elimination tree 701, the information processing device 100 specifies a pattern of non-zero elements of the lower triangular matrix L(A) and the upper triangular matrix U(A) obtained by LU factorizing the sparse matrix A.

For example, the information processing device 100 specifies as a root node a node related to a column having a diagonal element on the i^{th} row of the lower triangular matrix C(A), and specifies as a leaf node a node related to a column having a non-zero element other than diagonal elements. Then, the information processing device 100 approximates a pattern of non-zero elements on the i^{th} row of the lower triangular matrix L(A) by a subtree of the elimination tree 701 including the specified root and leaf nodes. Then, the information processing device 100 calculates the number of non-zero elements present in each column of the lower triangular matrix L(A) based on a pattern of the non-zero elements of each row of the lower triangular matrix L(A).

Similarly, the information processing device 100 specifies as a root node a node related to a column having a diagonal element on the i^{th} row of a transposed matrix R(A)̂T of the upper triangular matrix R(A), and specifies as a leaf node a node related to a column having a non-zero element other than diagonal elements. Then, the information processing device 100 approximates a pattern of non-zero elements on the i^{th} row of the transposed matrix U(A)̂T of the upper triangular matrix U(A) by a subtree of the elimination tree 701 including the specified root and leaf nodes. Then, the information processing device 100 calculates the number of non-zero elements present on each column of the transposed matrix U(A)̂T based on a pattern of non-zero elements of each row of the transposed matrix U(A)̂T.

The information processing device 100 specifies a pattern of non-zero elements on the 1^{st}, the 2^{nd}, the 4^{th}, the 6^{th} to the 9^{th}, and the 11^{th} rows of the transposed matrix R(A)̂T of the upper triangular matrix R(A) of the sparse matrix A of FIG. 5, for example. Then, the information processing device 100 determines from the specified pattern of non-zero elements that there is no leaf node on the 1^{st}, the 2^{nd}, the 4^{th}, the 6^{th} to the 9^{th}, and the 11^{th} rows of the transposed matrix U(A)̂T of the upper triangular matrix U(A). Then, the information processing device 100 approximates the pattern of non-zero elements of the 1^{st}, the 2^{nd}, the 4^{th}, the 6^{th} to the 9^{th}, and the 11^{th} rows of the transposed matrix U(A)̂T of the upper triangular matrix U(A) by a subtree corresponding to the 1^{st}, the 2^{nd}, the 4^{th}, the 6^{th} to the 9^{th}, and the 11^{th} rows of the transposed matrix U(A)̂T of the upper triangular matrix U(A).

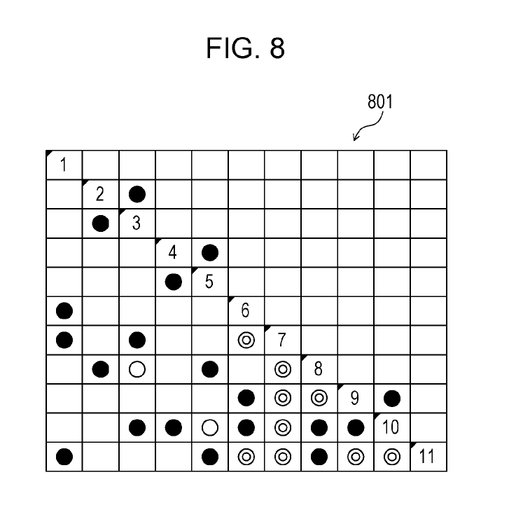

The information processing device 100 specifies leaf nodes present on the 3^{rd}, the 5^{th}, and the 10^{th} rows of the transposed matrix U(A)̂T of the upper triangular matrix U(A), from the pattern of the non-zero elements on the 3^{rd}, the 5^{th}, and the 10^{th} rows of the transposed matrix C(A)̂T of the lower triangular matrix C(A) of the sparse matrix A of FIG. 5. Then, the information processing device 100 approximates a pattern of non-zero elements on the 3^{rd}, the 5^{th}, and the 10^{th} rows of the transposed matrix U(A)̂T of the upper triangular matrix U(A) by a subtree corresponding to the 3^{rd}, the 5^{th}, and the 10^{th} rows of the transposed matrix U(A)̂T of the upper triangular matrix U(A). Here, another example of an approximated pattern of non-zero elements of the lower triangular matrix L(A) and the upper triangular matrix U(A) obtained by LU factorizing the sparse matrix A is described with reference to FIG. 8.

FIG. 8 is an explanatory diagram illustrating another example of an approximated pattern of non-zero elements of a lower triangular matrix L(A) and an upper triangular matrix U(A). In a grid 801 of FIG. 8, an approximated pattern of non-zero elements of the lower triangular matrix L(A) is represented by a lower triangular part divided by diagonal elements, and an approximated pattern of the non-zero elements of the upper triangular matrix U(A) is represented by an upper triangular part divided by the diagonal elements.

The box of the i^{th} row and the j^{th} column of the grid 801 of FIG. 8 corresponds to the element of the i^{th} row and the j^{th} column of the lower triangular matrix L(A) when i>j, and indicates that the element of the i^{th} row and the j^{th} column of the lower triangular matrix L(A) is any of a diagonal element, a zero element, a non-zero element, a fill-in, and a false fill-in. On the one hand, the box on the i^{th} row and the j^{th} column of the grid 801 of FIG. 8 corresponds to the element of the i^{th} row and the j^{th} column of the upper triangular matrix U(A) when i<j, and indicates that the element of the i^{th} row and the j^{th} column of the upper triangular matrix U(A) is any of a diagonal element, a zero element, a non-zero element, a fill-in, and a false fill-in.

Here, while the pattern of non-zero elements of FIG. 8 may have a larger number of fill-ins than the pattern of non-zero elements for the case in which the sparse matrix A is LU factorized, the pattern of non-zero elements of FIG. 8 includes the pattern of non-zero elements for the case in which the sparse matrix A is LU factorized. On the one hand, the pattern of non-zero elements of FIG. 8 is included in the pattern of non-zero elements for the case in which the symmetric matrix P is LL̂T factorized as illustrated in FIG. 6, and may have a smaller number of fill-ins than the pattern of non-zero elements for the case in which the symmetric matrix P is LL̂T factorized. In the example of FIG. 8, the number of fill-ins present on each row in the pattern of non-zero elements of FIG. 8 is smaller than the number of fill-ins present on the corresponding row in the pattern of non-zero elements for the case in which the symmetric matrix P is LL̂T factorized.

This enables the information processing device 100 to calculate a size of an area to store the lower triangular matrix L(A) with precision. The information processing device 100, for example, may calculate a size of an area which is smaller than an area based on a pattern of non-zero elements for the case in which the symmetric matrix P is LL̂T factorized and which may store the lower triangular matrix L(A) or the upper triangular matrix U(A) obtained by LU factorizing the sparse matrix A. As an area to store the lower triangular matrix L(A) and the upper triangular matrix U(A), the information processing device 100 specifically prepares an area to store indices of non-zero elements of each column of the lower triangular matrix L(A) and each row of the upper triangular matrix U(A), as well as an area to store non-zero elements.

In this manner, the information processing device 100 may reduce a size of an area to store a result of LU factorization, and store a result of LU factorization even if the sparse matrix A increases in size. For example, there is a case in which the degree of asymmetry of the sparse matrix A is high and there are non-zero elements only in the lower triangular matrix C(A). In this case, it is likely that the information processing device 100 may reduce the size of the area almost to half compared with a case in which the size of the area is calculated based on a pattern of non-zero elements for the case in which the symmetric matrix P is LL̂T factorized.

In addition, the information processing device 100 may omit any operation for which LU factorization does not have to be performed, and LU factorization may be performed efficiently. For example, there is a case in which the degree of asymmetry of the sparse matrix A is high and non-zero elements are present only in the lower triangular matrix C(A). In this case, it is likely that the information processing device 100 may reduce an amount of operation to almost half.

(Hardware of an Information Processing Device 100)

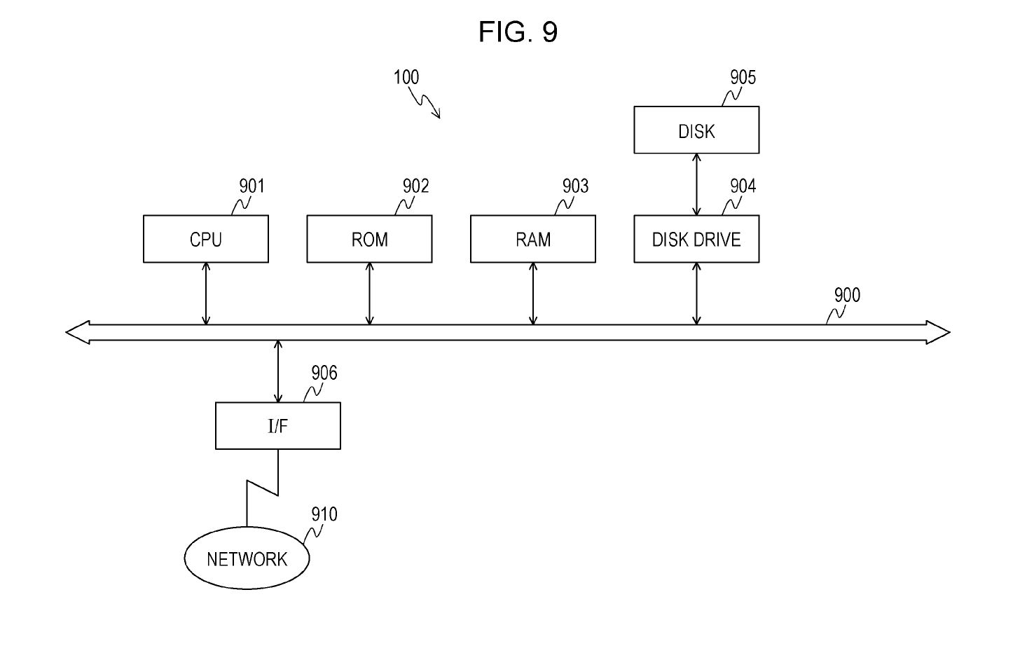

One example of hardware of an information processing device 100 according to the embodiment is described hereinafter with reference to FIG. 9.

FIG. 9 is a block diagram illustrating one example of the hardware of the information processing device 100 according to an embodiment. In FIG. 9, the information processing device 100 has a central processing unit (CPU) 901, a read only memory (ROM) 902, a random access memory (RAM) 903. In addition, the information processing device 100 further has a disk drive 904, a disk 905, and an interface (I/F) 906.

In addition, the CPU 901, the ROM 902, the RAM 903, the disk drive 904, and the I/F 906 are connected to each other by a bus 900. The information processing device 100 is, for example, a server, a personal computer (PC), a notebook PC, a tablet PC, or the like.

The CPU 901 is configured to control the entire information processing device 100. The ROM 902 is configured to store various programs such as a boot program and an information processing program. The RAM 903 is used as a working area of the CPU 901. The RAM 903 is also configured to store various types of data such as data obtained by execution of various programs. The disk drive 904 is configured to control reading/writing of data on the disk 905 through control of the CPU 901. The disk 905 is configured to store data written through control of the disk drive 904.

The I/F 906 is connected to a network 910 through a communication circuit and connected to other devices through this network 910. The network 910 is, for example, a local area network (LAN), a wide area network (WAN), the Internet, or the like. The I/F 906 is configured to manage the network 910 and an internal interface and control input/output of data to/from an external device. The I/F 906 is, for example, a modem or a LAN adapter, or the like.

The information processing device 100 may have a solid state drive (SSD) and a semiconductor memory, in place of the disk drive 904 and the disk 905. The information processing device 100 may also have at least any one of an optical disk, a display, a keyboard, a mouse, a scanner, and a printer.

(Functional Configuration Example of an Information Processing Device 100)

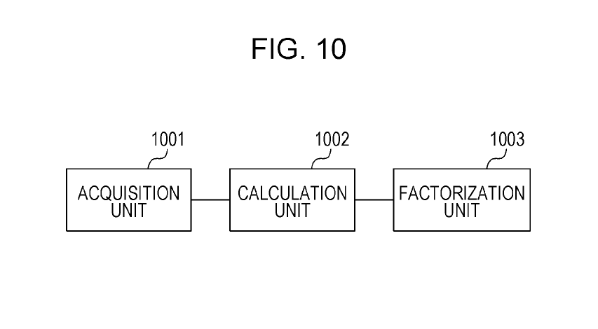

A functional configuration example of an information processing device 100 is described hereinafter with reference to FIG. 10.

FIG. 10 is a block diagram illustrating a functional configuration example of the information processing device 100. The information processing device 100 includes an acquisition unit 1001, a calculation unit 1002, and a factorization unit 1003 as functions that serve as a control unit.

The acquisition unit 1001 acquires a matrix to be LU factorized. A matrix to be LU factorized is, for example, the sparse matrix A as illustrated in FIG. 1 or FIG. 5, which has a pattern of non-zero elements. With this, the acquisition unit 1001 may input the sparse matrix A to the calculation unit 1002 to cause the calculation unit 1002 to calculate a size of an area to store a result of LU factorization of the sparse matrix A.

The acquired data is stored in a storage area such as the RAM 903 and the disk 905. The acquisition unit 1001 performs functions of the acquisition unit 1001, by causing the CPU 901 to execute a program stored in a storage device, such as the ROM 902, the RAM 903, and the disk 905, as illustrated in FIG. 9, or by the I/F 906.

The calculation unit 1002 generates from the sparse matrix A an elimination tree of a symmetric matrix P of the sparse matrix A. The calculation unit 1002 generates the elimination tree of the symmetric matrix P by, for example, specifying a pattern of non-zero elements of the symmetric matrix P of the sparse matrix A.

Here, if the calculation unit 1002 may specify the pattern of non-zero elements of the symmetric matrix P, the symmetric matrix P does not have to be generated. Alternatively, the calculation unit 1002 may generate an elimination tree of the symmetric matrix P, for example, rather than generating the symmetric matrix P, from the element a[i,j] and the element a[j,i] which are located at mutually symmetric positions of the sparse matrix A. Symmetric positions are positions that are symmetrical to diagonal elements, and are a position of the i^{th} row and the j^{th} column and a position of the j^{th} row and the i^{th} column. Details of generation of an elimination tree are described in the first to fourth processes of the example 1 to be described below.

The calculation unit 1002 extracts a subtree of each row of a lower triangular matrix C(A) of the sparse matrix A based on the generated elimination tree. A subtree of each row is a row subtree corresponding to each row. A subtree of each row is a subtree of an elimination tree having as a root node a node whose index is equal to a row number of the row and having as a leaf node a node whose index is equal to a column number of a column containing a non-zero element on the row. Then, the calculation unit 1002 calculates, for each of the nodes of the elimination tree, the number of subtrees including each node, among the subtrees of the rows of the extracted lower triangular matrix C(A).

The calculation unit 1002 specifies a pattern of non-zero elements of the lower triangular matrix C(A) of the sparse matrix A, for example, and extracts a subtree of each row of the lower triangular matrix C(A). Then, for each of the nodes of the elimination tree, the calculation unit 1002 counts how many subtrees including the node there are, and calculates the number of subtrees including the node.

Here, the calculation unit 1002 does not have to generate the lower triangular matrix C(A) if the calculation unit 1002 may specify a pattern of non-zero elements of the lower triangular matrix C(A). Details of calculation of the number of subtrees are described in the fifth process of the example 1 to be described below.

The calculation unit 1002 extracts a subtree of each row of a transposed matrix R(A)̂T of an upper triangular matrix R(A) of the sparse matrix A, based on the generated elimination tree. Then, the calculation unit 1002 calculates, for each of the nodes of the elimination tree, the number of subtrees including each node, among the subtrees of the rows of the extracted transposed matrix R(A)̂T.

The calculation unit 1002 specifies a pattern of non-zero elements of the transposed matrix R(A)̂T of the upper triangular matrix R(A) of the sparse matrix A, for example, to extract a subtree of each row of the transposed matrix R(A)̂T. Then, for each node of the elimination tree, the calculation unit 1002 counts how many subtrees including the node there are, and calculates the number of the subtrees including the node.

Here, the calculation unit 1002 does not have to generate the upper triangular matrix R(A) or the transposed matrix R(A)̂T if the calculation unit 1002 may specify a pattern of non-zero elements of the transposed matrix R(A)̂T. Details of calculation of the number of subtrees are described in the sixth process of the example 1 to be described below.

The calculation unit 1002 calculates an amount of memory area to store a result of LU factorization of the sparse matrix A, based on the respective numbers of the subtrees including respective nodes of the generated elimination tree. An amount of memory area is a size of an area to store a result of LU factorization. The calculation unit 1002 sets the number of subtrees including the respective nodes of the generated elimination tree, for example, which is obtained from the lower triangular matrix C(A), as the number of non-zero elements of the columns of a lower triangular matrix L(A) obtained by LU factorizing the sparse matrix A.

The calculation unit 1002 also sets the number of subtrees including the respective nodes of the generated elimination tree, which is obtained from the transposed matrix R(A)̂T, as the number of non-zero elements of the columns of a transposed matrix U(A)̂T of the upper triangular matrix U(A) obtained by LU factorizing the sparse matrix A. The number of non-zero elements of a column of the transposed matrix U(A)̂T corresponds to the number of non-zero elements of the corresponding row of the upper triangular matrix U(A). Then, the calculation unit 1002 calculates a size of an area to store a result of LU factorization based on the number of non-zero elements of the columns of the lower triangular matrix L(A) and the number of non-zero elements of the rows of the upper triangular matrix U(A). Details of calculation of the amount of memory area are described in the seventh process of the example 1 to be described below.

This enables the calculation unit 1002 to reduce the size of the area to store a result of LU factorization of the sparse matrix A. A calculation result is stored in a storage area such as the RAM 903 and the disk 905. The calculation unit 1002 performs functions of the calculation unit 1002 by causing the CPU 901 to execute a program stored in a storage device such as the ROM 902, the RAM 903, and the disk 905, as illustrated in FIG. 9.

The factorization unit 1003 reserves the size of the area calculated by the calculation unit 1002 and LU factorizes the sparse matrix A. The factorization unit 1003 reserves an area of the size calculated by the calculation unit 1002 in a storage area such as the RAM 903 and the disk 905, LU factorizes the sparse matrix A, and stores a result of the factorization of the sparse matrix A in the reserved area. The factorization unit 1003 performs functions of the factorization unit 1003 by causing the CPU 901 to execute a program stored in a storage device such as the ROM 902, the RAM 903 and the disk 905, as illustrated in FIG. 9.

### Example 1

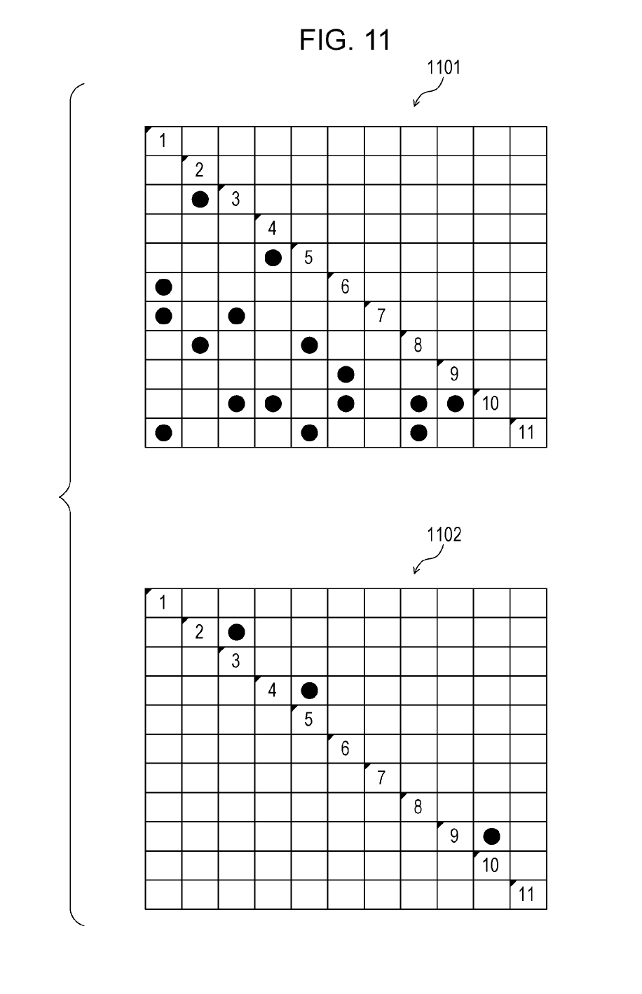

An example 1 is described hereinafter with reference to FIGS. 11 to 17. In the example 1, an information processing device 100 calculates an approximate size of an area to store a result of LU factorization of a sparse matrix A prior to the LU factorization of the sparse matrix A, and performs the LU factorization after reserving the area to store the result of LU factorization.

Here, taking as an example a sparse matrix A having the pattern of non-zero elements as illustrated in FIG. 5, various processes of the information processing device 100 calculating sizes of areas to store a lower triangular matrix L(A) and an upper triangular matrix U(A) obtained by LU factorizing the sparse matrix A are described.

<First Process>

First, a first process is described. In the first process, the information processing device 100 generates a lower triangular matrix C(A) and an upper triangular matrix R(A) from the sparse matrix A and specifies patterns of non-zero elements of the lower triangular matrix C(A) and the upper triangular matrix R(A). Here, the information processing device 100 generates each of the lower triangular matrix C(A) and the upper triangular matrix R(A) as a matrix where diagonal elements are non-zero elements.

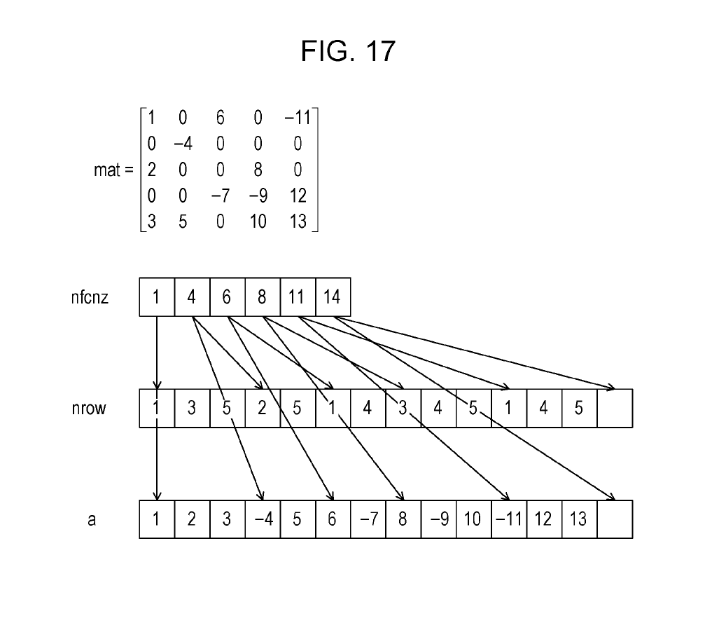

The information processing device 100 generates as the lower triangular matrix C(A) a matrix that has the same size as the sparse matrix A, for example, and in which the element a[i,j] (i<j) located to the right and above diagonal elements of the sparse matrix A is changed to a zero element. In the description below, the element present in the row i and the column j of the lower triangular matrix C(A) may be denoted by the “element c[i,j]”. Then, the information processing device 100 stores the generated lower triangular matrix C(A) using the compressed column storage method. The compressed column storage method is described below with reference to FIG. 17.

In addition, the information processing device 100 generates as the upper triangular matrix R(A) a matrix that has the same size as the sparse matrix A, and in which the element a[i,j] (i<j) located to the left and below the diagonal elements of the sparse matrix A is changed to a zero element. In the description below, the element present on the row i and the column j of the upper triangular matrix R(A) may be denoted by the “element r[i,j]”. Then, the information processing device 100 stores the generated upper triangular matrix R(A) using the compressed column storage method. The compressed column storage method is described below with reference to FIG. 17.

In other words, the information processing device 100 substantially stores a transposed matrix R(A)̂T of the generated upper triangular matrix R(A) with the compressed column storage method. Here, patterns of non-zero elements of the lower triangular matrix C(A) and the upper triangular matrix R(A) are described with reference to FIG. 11.

FIG. 11 is an explanatory diagram illustrating the patterns of non-zero elements of the lower triangular matrix C(A) and the upper triangular matrix R(A). A grid 1101 of FIG. 11 illustrates a pattern of non-zero elements of the lower triangular matrix C(A). The box of the i^{th} row and the j^{th} column of the grid 1101 of FIG. 11 corresponds to the element c[i,j] of the i^{th} row and the j^{th} column of the lower triangular matrix C(A), and indicates that the element c[i,j] of the i^{th} row and the j^{th} column of the lower triangular matrix C(A) is any of a diagonal element, a zero element, and a non-zero element.

In the example of FIG. 11, the box of the 1^{st} row and the 1^{st} column of the grid 1101 of FIG. 11 is represented by the row number “1” since the corresponding element c[1,1] of the 1^{st} row and the 1^{st} column of the lower triangular matrix C(A) is a diagonal element. In addition, for example, the box of the 2^{nd} row and the 3^{rd} column of the grid 1101 of FIG. 11 is represented by a “blank” because the corresponding element c[2,3] on the 2^{nd} row 2 and the 3^{rd} column of the lower triangular matrix C(A) is changed to a zero-element, regardless of the element a[2,3] of the 2^{nd} row and the 3^{rd} column of the sparse matrix A. In addition, the box of the 3^{rd} row and the 2^{nd} column of the grid 1101 of FIG. 11 is represented by a filled circle because the corresponding element c[3,2] of the 3^{rd} row and the 2^{nd} column of the lower triangular matrix C(A) is the element a[3,2] of the 3^{rd} row and the 2^{nd} column 2 of the sparse matrix A itself and is a non-zero element.

On the one hand, a grid 1102 of FIG. 11 illustrates a pattern of non-zero elements of the upper triangular matrix R(A). The box of the i^{th} row and the j^{th} column of the grid 1102 of FIG. 11 corresponds to the element r[i,j] of the i^{th} row and the j^{th} column of the upper triangular matrix R(A), and indicates that the element r[i,j] of the i^{th} row and the j^{th} column of the upper triangular matrix R(A) is any of a diagonal element, a zero element, and a non-zero element.

In the example of FIG. 11, the box of the 1^{st} row and the 1^{st} column of the grid 1102 of FIG. 11 is represented by the row number “1” because the corresponding element r[1,1] on the 1^{st} row and the 1^{st} column of the upper triangular matrix R(A) is a diagonal element. In addition, for example, the box of the 2^{nd} row and the 3^{rd} column of the grid 1102 of FIG. 11 is represented by a filled circle because the corresponding element r[2,3] of the 2^{nd} row and the 3^{rd} column of the upper triangular matrix R(A) is the element a[2,3] of the 2^{nd} row and the 3^{rd} column of the sparse matrix A itself and is a non-zero element. In addition, for example, the box of the 3^{rd} row and the 2^{nd} column of the grid 1102 of FIG. 11 is represented by a “blank” because the corresponding element r[3,2] of the 3^{rd} row and the 2^{nd} column of the upper triangular matrix R(A) is changed to a zero-element, regardless of the element a[3,2] of the 3^{rd} row and the 2^{nd} column of the sparse matrix A.

Here, although the case in which the information processing device 100 generates the lower triangular matrix C(A) and the transposed matrix R(A)̂T of the upper triangular matrix R(A) has been described, a case is not limited to this. For example, if the information processing device 100 may specify patterns of non-zero elements of the lower triangular matrix C(A) and of the transposed matrix R(A)̂T, the information processing device 100 does not have to generate the lower triangular matrix C(A) and the transposed matrix R(A)̂T. Then, the information processing device 100 proceeds to a second process.

<Second Process>

The second process is described hereinafter. In the second process, the information processing device 100 generates from the lower triangular matrix C(A) and the upper triangular matrix R(A) a lower triangular matrix C(P) of a symmetric matrix P=A+ÂT which is obtained by symmetrizing the sparse matrix A.

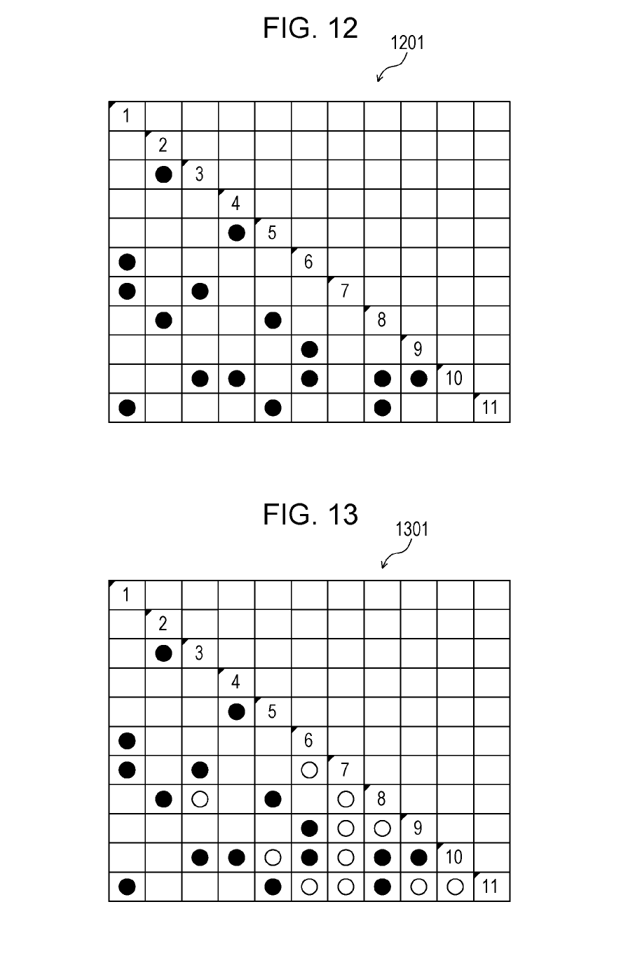

The information processing device 100 combines a pattern of non-zero elements of the lower triangular matrix C(A) with a pattern of non-zero elements of the transposed matrix R(A)̂T of the upper triangular matrix R(A), for example, to generate the lower triangular matrix C(P) of the symmetric matrix P, which is obtained by symmetrizing the sparse matrix A. In the description below, the element present on the i^{th} row and the j^{th} column of the symmetric matrix P may be represented as the “element p[i,j]”. In addition, in the description below, the element present on the i^{th} row and the j^{th} column of the lower triangular matrix C(P) may be denoted by the “element cp[i,j]”. When i>j, the element p[i,j]=the element cp[i,j]. Then, the information processing device 100 specifies a pattern of non-zero elements of the generated lower triangular matrix C(P). Here, the pattern of non-zero elements of the lower triangular matrix C(P) is described with reference to FIG. 12.

FIG. 12 is an explanatory diagram illustrating the pattern of non-zero elements of the lower triangular matrix C(P). The box of the i^{th} row and the j^{th} column of a grid 1201 of FIG. 12 corresponds to the element cp[i,j] of the i^{th} row and the j^{th} column of the lower triangular matrix C(P), and indicates that the element cp[i,j] of the i^{th} row and the j^{th} column of the lower triangular matrix C(P) is any of a diagonal element, a zero element, or a non-zero element.

In the example of FIG. 12, the box of the 2^{nd} row and the 3^{rd} column of the grid 1201 of FIG. 12 is represented by a “blank” because the corresponding element cp[2,3] of the 2^{nd} row and the 3^{rd} column of the lower triangular matrix C(P) is a zero element. In addition, for example, the box of the 3^{rd} row and the 2^{nd} column of the grid 1201 of FIG. 12 is represented by a filled circle because the corresponding element cp[3,2] of the 3^{rd} row and the 2^{nd} column of the lower triangular matrix C(P) is a non-zero element. The element c[3,2] of the 3^{rd} row and the 2^{nd} column of the lower triangular matrix C(P) is a sum of the element c[3,2] of the 3^{rd} row and he 2^{nd} column of the lower triangular matrix C(A) of the sparse matrix A and the element r[3,2] of the 3^{rd} row and the 2^{nd} column of the transposed matrix R(A)̂T of the upper triangular matrix R(A).

Here, although the case in which the information processing device 100 generates the lower triangular matrix C(P) has been described, a case is not limited to this. For example, if the information processing device 100 may specify a pattern of non-zero elements of the lower triangular matrix C(P), the information processing device 100 does not have to generate the lower triangular matrix C(P). Then, the information processing device 100 proceeds to a third process.

<Third Process>

The third process is described hereinafter. In the third process, the information processing device 100 generates an elimination tree of a symmetric matrix P based on a lower triangular matrix L(P) obtained by LL̂T factorizing the symmetric matrix P. First, the information processing device 100 generates the lower triangular matrix L(P) obtained by LL̂T factorizing the symmetric matrix P, based on a pattern of non-zero elements of a lower triangular matrix C(P) of the symmetric matrix P. In the description below, the element present on the i^{th} row and the j^{th} column of the lower triangular matrix L(P) may be represented as the “element l[i,j]”.

Here, according to the definition of the LL̂T factorization, since “symmetric matrix P=lower triangular matrix L(P)×transposed matrix L(P)̂T of lower triangular matrix L(P)”, for each element p[i,j] of the symmetric matrix P, the following expression (1) is true:

p[i,j]=Σₖ₌₁^{j}(l[i,k]×l[j,k]) (1)

Furthermore, by transforming the above expression (1), for each element l[i,j] (i>j) of the lower triangular matrix L(P), the following expression (2) and the following expression (3) are true.

$$\begin{matrix}l [ j , j ] = \sqrt{\{ p [ j , j ] - {\sum }_{k = 1}^{j - 1} ( l [ j , k ] \times l [ j , k ] ) \}} & ( 2 ) \\ l [ i , j ] = \frac{\{ p [ i , j ] - {\sum }_{k = 1}^{j - 1} ( l [ i , k ] \times l [ j , k ] ) \}}{l [ j , j ]} & ( 3 )\end{matrix}$$

For the expression (2) and the expression (3) mentioned above to be true, when generating a lower triangular matrix L(P), the information processing device 100 determines a diagonal element l[j,j] of the lower triangular matrix L(P) sequentially from j=1. Furthermore, after determining the diagonal element l[j,j] of the lower triangular matrix L(P), the information processing device 100 determines elements l[1,j] to l[j−1, j] of the j^{th} column of the lower triangular matrix L(P) sequentially from j=1. Here, a pattern of non-zero elements of the lower triangular matrix L(P) is described with reference to FIG. 13.

FIG. 13 is an explanatory diagram illustrating a pattern of non-zero elements of the lower triangular matrix L(P). The box on the i^{th} row and the j^{th} column of a grid 1301 of FIG. 13 corresponds to the element of the i^{th} row and the j^{th} column of the lower triangular matrix L(P), and indicates that the element of the i^{th} row and the j^{th} column of the lower triangular matrix L(P) is any of a diagonal element, a zero element, and a non-zero element. In the example of FIG. 13, the box of the 2^{nd} row and the 3^{rd} column of the grid 1301 of FIG. 13 is represented by a “blank” because the corresponding element l[2,3] of the 2^{nd} row and the 3^{rd} column of the lower triangular matrix L(P) is a zero element. In addition, for example, the box of the 3^{rd} row and the 2^{nd} column of the grid 1301 of FIG. 13 is represented by a filled circle because the corresponding element l[3,2] of the 3^{rd} row and the 2^{nd} column of the lower triangular matrix L(P) is a non-zero element. In addition, for example, the box of the 7^{th} row and the 6^{th} column of the grid 1301 of FIG. 13 is represented by an open circle because the corresponding element l[7,6] of the 7^{th} row and the 6^{th} column of the lower triangular matrix L(P) is a fill-in.

Then, based on a pattern of non-zero elements of the lower triangular matrix L(P), the information processing device 100 generates an elimination tree of the symmetric matrix P for the case in which the symmetric matrix is LL̂T factorized and expressed P by L(P)×L(P)̂T.

Here, according to the above-mentioned expression (2) and the above-mentioned expression (3), if the i^{th} row and the k^{th} column of the lower triangular matrix L(P) is a non-zero element, the element of the k^{th} column of the lower triangular matrix L(P) influences when calculating the element of the i^{th} column of the lower triangular matrix L(P). On the one hand, if the i^{th} row and the k^{th} column of the lower triangular matrix L(P) is a zero-element, the element of the k^{th} column of the lower triangular matrix L(P) does not influence when calculating the element of the i^{th} column of the lower triangular matrix L(P).

The elimination tree includes nodes related to the columns of the lower triangular matrix L(P). When the element of the j^{th} column influences the element of the i^{th} column, the elimination tree connects the node related to the i^{th} column and the node related to the j^{th} column so that the node related to the i^{th} column and the node related to the j^{th} column are in a parent-child relationship. When the element of the j^{th} column influences the element of the i^{th} column, for example, the elimination tree sets the node related to the i^{th} column as a parent node, and the node related to the j^{th} column as a child node.

Thus, the parent node of the node[j] related to the j^{th} column is the node[i] related to the i^{th} column that satisfies min{i|i>j and L[i,j]≠0}. In other words, on the j^{th} column of the lower triangular matrix L(P), the parent node of the node[j] related to the j^{th} column is the node[i] that is a non-zero element other than a diagonal element, and related to a column number of a column matching a row number of a row where an element closest to the diagonal element is present.

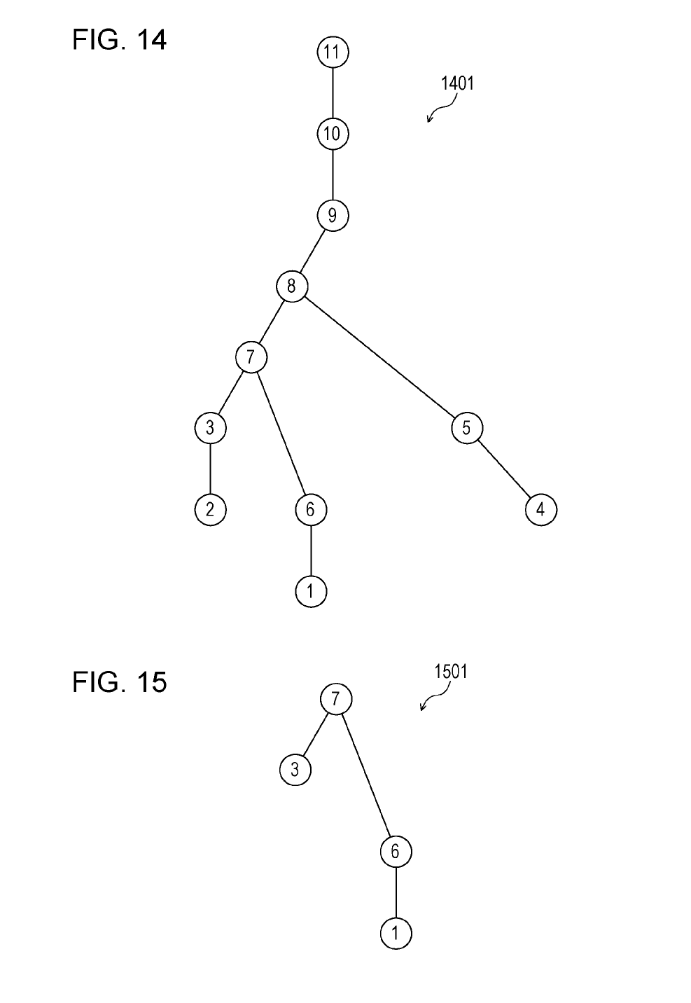

The generated elimination tree is a tree that expresses locations where fill-ins are generated by LL̂T factorization. In addition, the parent-child relationship between the node[j] and the node[i] may be expressed as nparent[j]=i using an array nparent[j], for example. Here, an elimination tree is described with reference to FIG. 14.

FIG. 14 is an explanatory diagram illustrating an elimination tree 1401. The elimination tree 1401 includes a node[1] to a node[11] related to the 1^{st} column to the 11^{th} column. In the example of FIG. 14, in the elimination tree 1401, a parent node of the node[1] is a node[6]. The parent-child relationship between the node[1] and the node[6] indicates that in the process of LL̂T factorization, elements of the 1^{st} column of the lower triangular matrix L(P) influence elements of the 6^{th} column of the lower triangular matrix L(P), and that a fill-in may be generated on the 6^{th} column of the lower triangular matrix L(P).

In addition, in the elimination tree 1401, a parent node of the node[6] is a node[7]. The parent-child relationship between the node[6] and the node[7] indicates that in the process of LL̂T factorization, elements of the 6^{th} column of the lower triangular matrix L(P) influence elements of the 7^{th} column of the lower triangular matrix L(P), and that a fill-in may be generated of the 7^{th} column of the lower triangular matrix L(P). Then, elements of the 1^{st} column of the lower triangular matrix L(P) indirectly influence the elements of the 7^{th} column of the lower triangular matrix L(P), and that a fill-in may be generated on the 7^{th} column of the lower triangular matrix L(P). Then, the information processing device 100 proceeds to a fourth process.

<Fourth Process>

The fourth process is described hereinafter. In the fourth process, for example, the information processing device 100 sets a parameter related to the elimination tree 1401. The information processing device 100 traces parent nodes, and sets a node whose parent node may no longer be traced, as a root node of the elimination tree 1401. In addition, when setting a node[p] as a parent node of a node[q], the information processing device 100 also sets the node[q] as a child node of the node[p].

In addition, when depth priority search is performed from the root node of the elimination tree 1401, the information processing device 100 assigns the order by which nodes are searched, as post-order of the nodes. In the example of FIG. 14, the information processing device 100 allocates each of post-orders “1 to 11” in the order of nodes [2, 3, 1, 6, 7, 4, 5, 8, 9, 10, 11] of the elimination tree 1401. In addition, if the information processing device 100 fails to search deeper than a certain node when depth priority search is performed from the root node of the elimination tree 1401, the information processing device 100 sets the node as a leaf node.

In addition, the information processing device 100 traces parent nodes from leaf nodes, and associates the leaf node with each node on a path traced back to the root node of the elimination tree 1401. When there are leaf nodes associated with a node, the information processing device 100 associates the leaf node with the smallest post-order assigned, of the leaf nodes. In addition, the information processing device 100 sets a leaf node associated with a node as a first descendant of the node. Then, the information processing device 100 proceeds to a fifth process.

<Fifth Process>

Then, the fifth process is described hereinafter. In the fifth process, the information processing device 100 calculates the number of non-zero elements of each column of the lower triangular matrix L(A) obtained by LU factorizing the sparse matrix A.

For example, the information processing device 100 calculates the number of non-zero elements of each column of the lower triangular matrix C(A) obtained by LU factorizing the sparse matrix A, based on the elimination tree 1401 and the pattern of non-zero elements of the lower triangular matrix L(A).

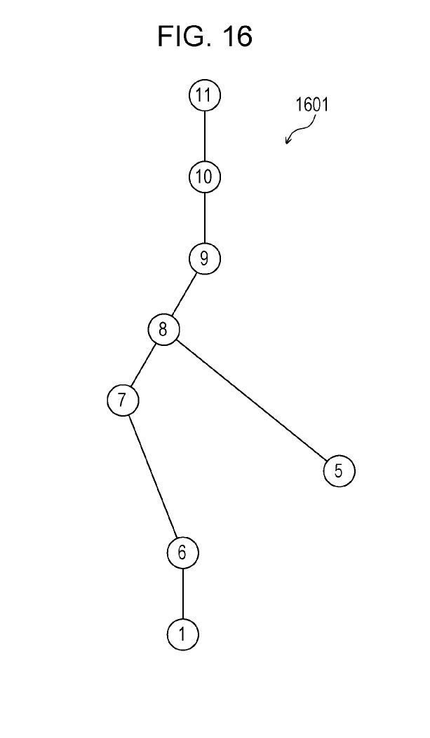

Here, when the vector on the i^{th} column of a lower triangular matrix C(P) of the symmetric matrix P is denoted by bj, the pattern of non-zero elements of the LU factorized lower triangular matrix L(A) is union of the bj and the vector bk on the k^{th} column of the lower triangular matrix L(A) related to a child node[k] of the node[j]. Thus, non-zero elements on the i^{th} row of the lower triangular matrix L(A) may be expressed as a subtree of the elimination tree 1401. For example, a non-zero element on the i^{th} row of the lower triangular matrix L(A) may be expressed as a subtree having a node[i] as a root node. Here, one example of a subtree is described with reference to FIG. 15 and FIG. 16.

FIG. 15 is an explanatory diagram illustrating one example of a subtree 1501 that expresses non-zero elements on the 7^{th} row. Here, the information processing device 100 specifies a column number of a column where a non-zero element other than a diagonal element is present and extracts the subtree 1501. In the example of FIG. 15, the information processing device 100 determines that the non-zero elements on the 7^{th} row of the sparse matrix A are present on the 1^{st} and 3^{rd} columns, excluding the diagonal element.

Since the subtree 1501 expresses the non-zero elements on the 7^{th} row, a node[7] related to the 7^{th} column is a root node. In addition, a node[1] related to the 1^{st} column where there is a non-zero element is a leaf node, and connected to the node[7] which is the root node, by way of a node[6]. In addition, a node[3] related to the 3^{rd} column where there is a non-zero element is a leaf node, and connected to the node[7].

Thus, the subtree 1501 having the node[7] as the root node is a tree including the nodes[1, 6, 3, 7] of the elimination tree 1401. The nodes[1,3] are leaf nodes. Here, on the 7^{th} row of the lower triangular matrix L(A) obtained by LU factorizing the sparse matrix A, the subtree 1501 of FIG. 15 expresses that a fill-in may be generated on the 1^{st}, 3^{rd}, and 6^{th} columns.

FIG. 16 is an explanatory diagram illustrating one example of a subtree 1601 that expresses non-zero elements on the 11^{th} row. Here, the information processing device 100 specifies a column number of a column where there is a non-zero element other than a diagonal element and extracts the subtree 1601. In the example of FIG. 16, the information processing device 100 determines that the non-zero elements on the 11^{th} row of the sparse matrix A are present on the 1^{st}, 5^{th}, and 8^{th} columns, excluding the diagonal element.

Since the subtree 1601 expresses non-zero elements on the 11^{th} row, a node[11] related to the 11^{th} column is a root node. In addition, a node[1] related to the 1^{st} column where there is a non-zero element is a leaf node and connected to the node[11], which is the root node, by way of nodes[6, 7, 8, 9, 10]. In addition, the node[5] related to the 5^{th} column where there is a non-zero element is a leaf node and connected to the node[11] by way of nodes[8, 9, 10]. In addition, the node[8] related to the 8^{th} column where there is a non-zero element is connected to the node[11] by way of the nodes[9, 10].

Thus, the subtree 1601 having the node[11] as the root node is a tree including nodes[1, 5 to 11] of the elimination tree 1401. The nodes[1, 5] are leaf nodes. Here, on the 11^{th} row of the lower triangular matrix L(A) obtained by LU factorizing the sparse matrix A, the subtree 1601 of FIG. 16 expresses that a fill-in may be generated on the 1^{st}, 5^{th} to 11^{th} columns.

The information processing device 100 specifically retrieves in the order of assigned post-order nodes related to columns where there are the non-zero elements present on the 11^{th} row of the lower triangular matrix C(A). Here, nodes[1, 4, 2] are respectively set as the first descendants of nodes[1, 5, 8] related to elements on the 1^{st}, 5^{th}, and 8^{th} columns. Since the information processing device 100 first retrieves the node[1], the node[1] is a leaf node.

In addition, when retrieving a node[5], the information processing device 100 detects that the post-order assigned to a node[4] which is a first descendant of the node[5] is larger than the post-order assigned to the node[1]. Thus, the information processing device 100 sets the node[5] as a leaf node assuming that the node[5] branches at a branching node. In addition, since the post-order assigned to a node[2] which is a first descendant of a node[8] is smaller than the post-order assigned to the node[5], the information processing device 100 does not set the node[8] as a leaf node assuming that there is no branching between the nodes[5,8]. Then, the information processing device 100 extracts the subtree 1601 including the leaf nodes to the root node, from the elimination tree 1401.

In this manner, the information processing device 100 retrieves nodes related to columns where there are non-zero elements on a row of the sparse matrix A in the order of assigned post-order. Then, the information processing device 100 compares the post-order assigned to the node that is last retrieved with the post-order assigned to a first descendant of a node that is currently retrieved. Now, the two nodes, namely, the last retrieved node and the currently retrieved node, are assigned the post-order through the depth first search. Thus, if the post-order assigned to the first descendant of the currently retrieved node is larger, it means that the nodes branch at a common ancestor. Then, as a result of the comparison, if the first descendant of the currently retrieved node is larger, the information processing device 100 sets the currently retrieved node as a leaf node and extracts the subtree 1601 from the elimination tree 1401.

In addition, instead of retrieving nodes related to columns where there are non-zero elements on a row in the order of assigned post-order and storing the last node, the information processing device 100 may store the last leaf node and update the leaf node when a new leaf node is found.

Here, the subtrees 1501, 1601, or the like express non-zero elements on the corresponding rows. Thus, the number of non-zero elements on the j^{th} column of the lower triangular matrix L(A) is the number of subtrees including a node[j], of the subtrees of the elimination tree 1401 such as the subtrees 1501 and 1601. This enables the information processing device 100 to calculate the number of non-zero elements with the amount of operation of O(|L(A)|) where |L(A)| represents the number of non-zero elements of the matrix L(A).

Here, a pattern of non-zero elements of the lower triangular matrix C(A) and the upper triangular matrix R(A) is a subset of a pattern of non-zero elements of the symmetric matrix P. Thus, the patterns of non-zero elements of the lower triangular matrix C(A) and the upper triangular matrix R(A) and the pattern of non-zero elements of the symmetric matrix P have an inclusion relation, and the lower triangular matrix C(A)⊂ the symmetric matrix P and the transposed matrix R(A)̂T of the upper triangular matrix R(A)⊂ the symmetric matrix P are true.

In addition, a subtree extracted by examining non-zero elements of the lower triangular matrix C(A) or the transposed matrix R(A)̂T of the upper triangular matrix R(A) has a smaller number of nodes than the subtree extracted from the symmetric matrix P. In addition, since the elimination tree 1401 of the symmetric matrix P is used, the number of non-zero elements calculated in the fifth process described above may be larger than the actual number of non-zero elements. More specifically, the number of non-zero elements (column count) on each column of the lower triangular matrix C(A) and the transposed matrix R(A)̂T of the upper triangular matrix R(A) is equal to or smaller than the number of non-zero elements on the corresponding column of the symmetric matrix P.

<Another Example of the Fifth Process>

Another example of the fifth process is described hereinafter. Another example of the fifth process is one example in which an information processing device 100 uses a characteristic function to calculate the number of non-zero elements of each column of a lower triangular matrix L(A) obtained by LU factorizing a sparse matrix A.

Here, the characteristic function illustrated in the expression (4) and the expression (5) below is prepared. Row subtree i is a row subtree on the 1^{st} row.

$$\begin{matrix}\begin{matrix}xi ( j ) = 1 if j ∈ row subtree i \\ 0 otherwise\end{matrix} & ( 4 ) \\ column count ( j ) = {\sum }_{i ∈ elimination tree} \{ xi ( j ) \} & ( 5 )\end{matrix}$$

The characteristic function sets 1 to a leaf node of the subtree 1601 and 0 for any node other than the leaf node. Then, the characteristic function is updated when the elimination tree 1401 is traced in the order of the post-order assigned to each node by the information processing device 100, and a value of a characteristic function of a child node is propagated and added.

For example, for a leaf node of the subtree 1601, the characteristic function sets 1. In addition, the characteristic function adds 1−d when there are d child nodes that reach the leaf node of the subtree 1601. In addition, the characteristic function adds −1 for a parent node of a root node of the subtree 1601.

In practice, the information processing device 100 scans rows corresponding to the root node of the subtree 1601 in the order of the post-order, and may calculate by making a pair with the last leaf node and adding −1 to a node of a common ancestor of the pair. An ancestor is a node of an ancestor. A common ancestor is a node of an ancestor common to the nodes forming a pair and closest to the pair node.

The information processing device 100 prepares a variable column count for each node, traces nodes in the order of the post-order, and adds a column count of a child node to a column count of a parent node. With this, “1” set to a leaf node, when included in each subtree 1601, propagates along branches of the elimination tree 1401, thus create the characteristic function. For a node with a number of child nodes, a value is adjusted and propagation of the value is cancelled in a parent node of a root node of the subtree 1601.

<Sixth Process>

The sixth process is described hereinafter. In the sixth process, the information processing device 100 calculates the number of non-zero elements of each column of a transposed matrix U(A)̂T of an upper triangular matrix U(A) obtained by LU factorizing a sparse matrix A. The information processing device 100 calculates the number of non-zero elements of each column of the transposed matrix U(A)̂T from, for example, the elimination tree 1401 and a pattern of non-zero elements of the transposed matrix R(A)̂T of the upper triangular matrix R(A) of the sparse matrix A.

Here, if a lower triangular matrix C(A) of the sparse matrix A in the fifth process is replaced by the transposed matrix R(A)̂T of the upper triangular matrix R(A) of the sparse matrix A, the information processing device 100 may similarly calculate the number of non-zero elements of each column of the transposed matrix U(A)̂T. Thus, a description of calculation of the number of non-zero elements of each column of the transposed matrix U(A)̂T is omitted.

<Seventh Process>

A seventh process is described hereinafter. In the seventh process, the information processing device 100 calculates a size of an area to store a result of LU factorization of a sparse matrix A.

The information processing device 100 calculates a size of an area to store a lower triangular matrix L(A) obtained by LU factorizing the sparse matrix A, based on a total number of non-zero elements of the lower triangular matrix L(A) obtained by LU factorizing the sparse matrix A, for example. The information processing device 100 also calculates a size of an area to store a transposed matrix U(A)̂T of an upper triangular matrix U(A) obtained by LU factorizing the sparse matrix A, based on a total number of non-zero elements of the transposed matrix U(A)̂T of the upper triangular matrix U(A) obtained by LU factorizing the sparse matrix A.

Specifically, the information processing device 100 calculates a size of an area desired for storing columns of the lower triangular matrix L(A) with the compressed column storage method by adding all column counts of respective columns of the lower triangular matrix L(A). Since the upper triangular matrix U(A) is a unit upper triangular matrix, the diagonal elements of the upper triangular matrix U(A) are 1. More specifically, the diagonal elements of the upper triangular matrix U(A) do not have to be stored. Here, a column count of each column of the transposed matrix U(A)̂T of the upper triangular matrix U(A) is the number of non-zero elements of the corresponding row of the upper triangular matrix U(A). Thus, the information processing device 100 calculates the size desired for storing non-zero elements excluding diagonal elements with the compressed column storage method, by subtracting 1 from the number of non-zero elements of each row of the upper triangular matrix U(A) and adding all the resulting values.

(One Example of the Compressed Column Storage Method)

Here, one example of the compressed column storage method is described with reference to FIG. 17. FIG. 17 is an explanatory diagram illustrating one example of the compressed column storage method.

The information processing device 100 compresses non-zero elements on each column of a matrix mat of FIG. 17 and sequentially stores the non-zero elements in an array a. Then, the information processing device 100 stores in an array nrow in the same order information indicating in what row an element stored in the array a is located. Then, the information processing device 100 stores in an array nfcnz information indicating in what location in array a a first non-zero element of each column is stored.

Here, a size of the one-dimensional array nfcnz is n+1 where an order of the matrix mat is n and the total number of non-zero elements is nz, and a virtual position of nz+1 is stored in the 6^{th} element of the array nfcnz. Similarly to the array a, the array nfcnz also indicates a position to the array nrow. The array a and the array nrow are a one-dimensional array of the size nz.

The array a is of the double-precision complex type, for example. The array nfcnz and the array nrow are of the integer type, for example. Since the compressed row storage method here is similar to a case in which a matrix to store is transposed and stored with the compressed column storage method, the description is omitted.

(One Example of Calculation Procedure)

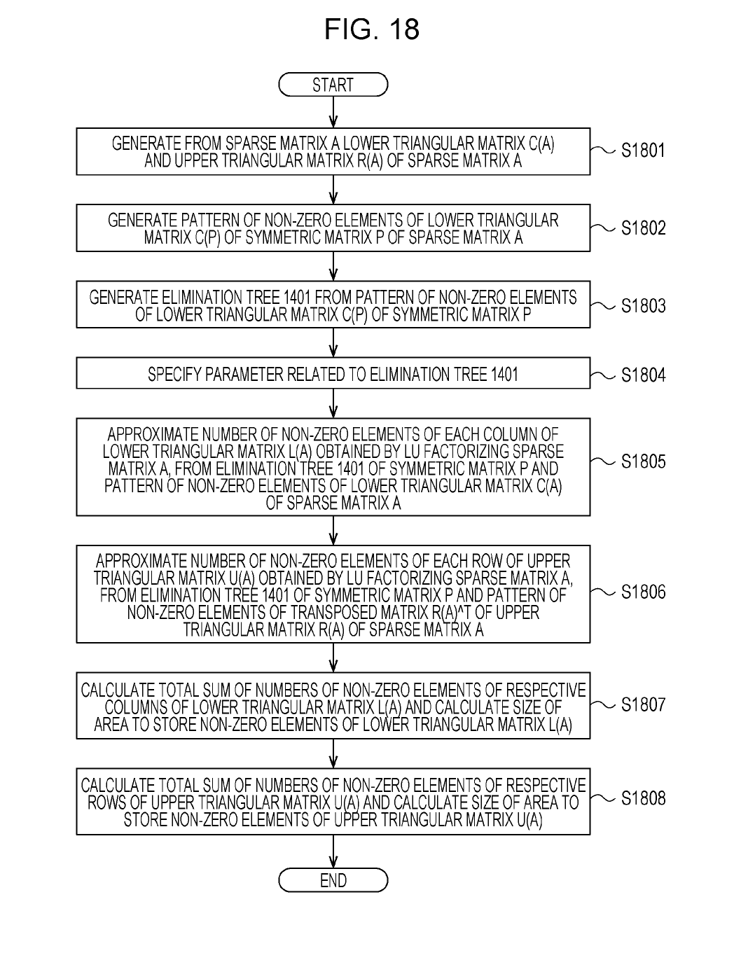

One example of a calculation procedure according to the example 1 is described hereinafter with reference to FIG. 18.

FIG. 18 is a flow chart illustrating one example of a calculation procedure according to the example 1. In FIG. 18, the information processing device 100 first generates from a sparse matrix A a lower triangular matrix C(A) and an upper triangular matrix R(A) of the sparse matrix A (step S1801).

Then, the information processing device 100 merges patterns of non-zero elements of the lower triangular matrix C(A) and a transposed matrix R(A)̂T of the upper triangular matrix R(A), and generates a pattern of non-zero elements of a lower triangular matrix C(P) of a symmetric matrix P of the sparse matrix A (step S1802). Then, the information processing device 100 generates an elimination tree 1401 of the symmetric matrix P from the pattern of non-zero elements of the lower triangular matrix C(P) of the symmetric matrix P (step S1803).

Then, the information processing device 100 specifies a parameter related to the elimination tree 1401 (step S1804). Then, the information processing device 100 approximates the number of non-zero elements of each column of a lower triangular matrix L(A) obtained by LU factorizing the sparse matrix A, from the elimination tree 1401 and the pattern of non-zero elements of each column of the lower triangular matrix C(A) of the sparse matrix A (step S1805).

Then, the information processing device 100 approximates the number of non-zero elements of each row of an upper triangular matrix U(A) obtained by LU factorizing the sparse matrix A, from the elimination tree 1401 and the pattern of non-zero elements of the transposed matrix R(A)̂T of the upper triangular matrix R(A) of the sparse matrix A (step S1806). Then, the information processing device 100 calculates a total sum of the numbers of non-zero elements of respective columns of the lower triangular matrix L(A), and calculates a size of an area to store the non-zero elements of the lower triangular matrix L(A) (step S1807).

Then, the information processing device 100 calculates a total sum of the numbers of non-zero elements of respective rows of the upper triangular matrix U(A), and calculates a size of an area to store the non-zero elements of the upper triangular matrix U(A) (step S1808). Then, the information processing device 100 finishes the calculation process. This enables the information processing device 100 to calculate a size of an area to store a result of LU factorization of the sparse matrix A.

### Example 2

An example 2 is described hereinafter. The example 2 is one example in which an information processing device 100 uses a supernode to calculate a size of an area to store a lower triangular matrix L(A) and an upper triangular matrix U(A). In the example 2, the information processing device 100 calculates the number of non-zero elements of each column of the lower triangular matrix L(A) and the number of non-zero elements of each column of a transposed matrix U(A)̂T of the upper triangular matrix U(A) obtained by LU factorizing a sparse matrix A by the first to sixth processes, similarly to the example 1.

In the example 2, the information processing device 100 calculates column counts of respective rows of a symmetric matrix P from a pattern of non-zero elements of the symmetric matrix P, and specifies a supernode which is a collection of nodes when LL̂T factorizing the symmetric matrix P. A supernode is a collection of continuous nodes of an elimination tree 1401. A supernode collects nodes when a pattern of non-zero elements present in a column corresponding to a node with a larger index matches a pattern of non-zero elements present in a column corresponding to a node with a smaller index.

A supernode may collect nodes when a pattern of non-zero elements present in a column corresponding to a node with a larger index is similar to a pattern of non-zero elements present in a column corresponding to a node with a smaller index. Columns corresponding to nodes that are collected as a supernode are a panel.

Here, a condition satisfied by nodes to be collected as a supernode is that a parent node of the nodes is a right-end column of a panel, which is a collection of columns corresponding to the nodes to be collected as a supernode. Then, a condition satisfied by the nodes to be collected as a supernode is that, of the nodes, another node is a descendant of the parent node. In addition, a condition satisfied by the nodes to be collected as a supernode is that another node which is between the parent node and the descendant is included. If the parent corresponds to the right-end column of the panel when generating a supernode by merging child nodes, the number of non-zero elements in any part other than a diagonal part is a “column count−1” of the parent node.

The information processing device 100 adopts nodes collected as a supernode when LL̂T factorizing the symmetric matrix P, as nodes for collecting as a supernode for the lower triangular matrix L(A) obtained by LU factorizing the sparse matrix A. The information processing device 100 adopts the nodes collected as a supernode when LL̂T factorizing the symmetric matrix P, as nodes for collecting as a supernode for the transposed matrix U(A)̂T of the upper triangular matrix U(A) obtained by LU factorizing the sparse matrix A. This enables the information processing device 100 to calculate a size of an area to store the supernodes for the lower triangular matrix L(A) and the transposed matrix U(A)̂T of the upper triangular matrix U(A).

When the number of nodes included in a supernode as a size of the supernode is b and the right-end node is e, columns of the lower triangular matrix L(A) corresponding to the supernode is collectively stored in a panel having a size of (b+lcc(e)−1)×b where lcc(e) is a column count of the node e of the lower triangular matrix L(A). In addition, for columns of the upper triangular matrix U(A) corresponding to the supernode, since a diagonal element is stored in the panel of the lower triangular matrix L(A), remaining elements are stored in a panel of (utcc(e)−1)×b where utcc(e) is a column count of the node e in the upper triangular matrix U(A).

The information processing device 100 may store in the format, in which a column or row having non-zero elements is compressed, a supernode that is a set of continuous nodes in the elimination tree 1401 and that is a collection of nodes for which patterns of non-zero elements present on a column corresponding to the node match. Thus, the information processing device 100 stores data of any column or row having non-zero elements, and no longer stores data of any column or row having no non-zero elements, which thus makes it possible to reduce a size of a storage area.

(One Example of a Calculation Procedure)

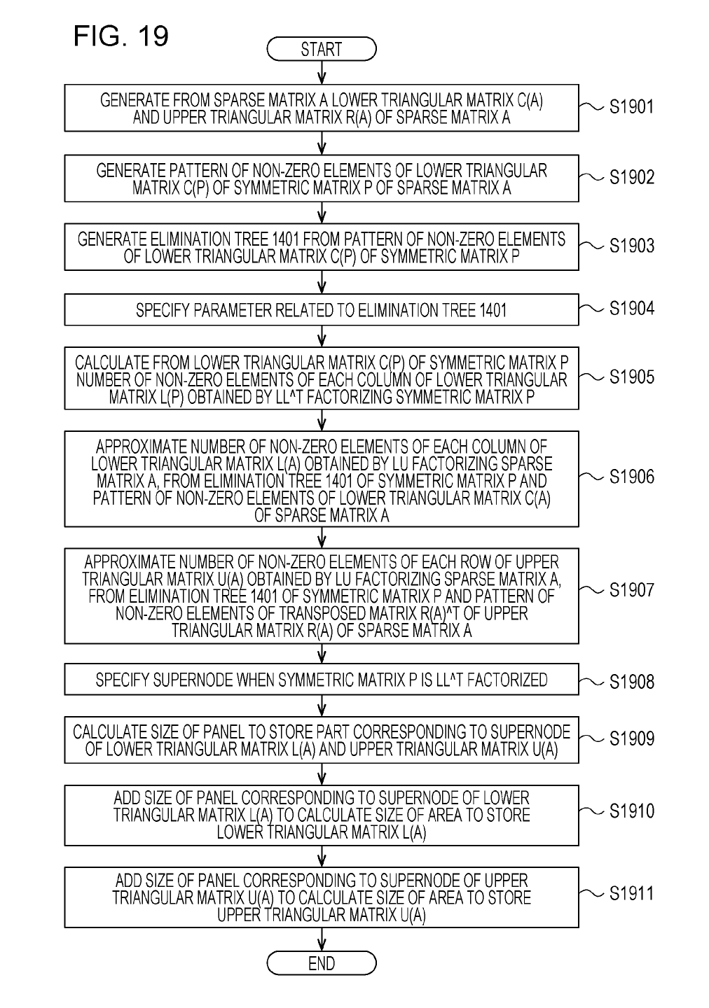

One example of a calculation procedure according to the example 2 is described hereinafter with reference to FIG. 19.

FIG. 19 is a flow chart illustrating one example of the calculation procedure according to the example 2. In FIG. 19, from a sparse matrix A, the information processing device 100 first generates a lower triangular matrix C(A) and an upper triangular matrix R(A) of the sparse matrix A (step S1901).

Then, the information processing device 100 merges patterns of non-zero elements of the lower triangular matrix C(A) and a transposed matrix R(A)̂T of the upper triangular matrix R(A) to generate a pattern of non-zero elements of a lower triangular matrix C(P) of a symmetric matrix P of the sparse matrix A (step S1902). Then, the information processing device 100 generates an elimination tree 1401 of the symmetric matrix P from a pattern of non-zero elements of the lower triangular matrix C(P) of the symmetric matrix P (step S1903).

Then, the information processing device 100 specifies a parameter related to the elimination tree 1401 (step S1904). Then, the information processing device 100 calculates from the lower triangular matrix C(P) of the symmetric matrix P the number of non-zero elements of each column of a lower triangular matrix L(P) obtained by LL̂T factorizing the symmetric matrix P (step S1905).

Then, the information processing device 100 approximates the number of non-zero elements of each column of a lower triangular matrix L(A) obtained by LU factorizing the sparse matrix A, from the elimination tree 1401 and the pattern of non-zero elements of the lower triangular matrix C(A) of the sparse matrix A (step S1906). Then, the information processing device 100 approximates the number of non-zero elements of each row of an upper triangular matrix U(A) obtained by LU factorizing the sparse matrix A, from the elimination tree 1401 and the pattern of non-zero elements of a transposed matrix R(A)̂T of the upper triangular matrix R(A) of the sparse matrix A (step S1907). Specifically, the process in step S1906 and the process in step S1907 are achieved by performing a process to calculate a column count to be described below.

Then, the information processing device 100 specifies a supernode for the case in which the symmetric matrix P is LL̂T factorized (step S1908). Then, the information processing device 100 calculates a size of a panel to store parts of the lower triangular matrix L(A) and the upper triangular matrix U(A) which correspond to the supernode (step S1909).

Then, the information processing device 100 adds the size of the panel corresponding to the supernode of the lower triangular matrix L(A) to calculate a size of an area to store the lower triangular matrix L(A) (step S1910). Then, the information processing device 100 adds the size of the panel corresponding to the supernode of the upper triangular matrix U(A) to calculate a size of an area to store the upper triangular matrix U(A) (step S1911). Subsequently, the information processing device 100 finishes the calculation process. This enables the information processing device 100 to calculate a size of an area to store a result of LU factorization of the sparse matrix A.

(Details of Calculation of a Column Count)

Details of calculation of a column count by the information processing device 100 are described below. A process to calculate a column count corresponds to a process in step S1906 and step S1907 of approximating the number of non-zero elements of each column of the lower triangular matrix L(A) and the number of non-zero elements of each row of the upper triangular matrix U(A) obtained by LU factorizing the sparse matrix A.

Here, the number of nodes is n. A node[j] being a parent node of a node[i] is represented by j=nparent(i). The information processing device 100 prepares a one-dimensional array nrow(nz). nz is a total number of non-zero elements of a lower triangular matrix. The one-dimensional array nrow(nz) is an array in which row numbers of non-zero elements of the columns are stored. The information processing device 100 also prepares a one-dimensional array nparent(n). The one-dimensional array nparent(n) is an array that expresses an elimination tree 1401. The information processing device 100 also prepares a one-dimensional array nposto(n). The one-dimensional array nposto(n) is an array in which a post-order is stored.

The information processing device 100 also prepares a one-dimensional array npostoinv(n). The one-dimensional array npostoinv(n) is an array in which nodes are stored in the order of post-order. The information processing device 100 also prepares a one-dimensional array nfirstdescendant(n). The one-dimensional array nfirstdescendant(n) is an array in which first descendant of the nodes are stored.

The information processing device 100 also prepares a one-dimensional array nprevp(n). The one-dimensional array nprevp(n) is an array in which leaf nodes that are detected in last row subtree are stored. An initial value of the one-dimensional array nprevp(n) is 0. The information processing device 100 also prepares a one-dimensional array nrowsubflag(n). The one-dimensional array nrowsubflag(n) is an array in which information indicating whether or not a row subtree has a leaf node is stored. An initial value of the one-dimensional array nrowsubflag(n) is 0.

The information processing device 100 also prepares a one-dimensional array nskeletonmat(n). When the node[i] is a leaf node of the row subtree, 1 is added to the one-dimensional array nskeletonmat (i). An initial value of the one-dimensional array nskeletonmat(i) is 0. The information processing device 100 also prepares a one-dimensional array ndelta(n). An element corresponding to a common ancestor ica for a pair of leaf nodes is stored, and −1 is added to the one-dimensional array ndelta(n). An initial value of the one-dimensional array ndelta(n) is 0.

The information processing device 100 also prepares a one-dimensional array nccount(n). The one-dimensional array nccount(n) is an array in which the number of non-zero elements, column count, of a column corresponding to each node is stored. The information processing device 100 also prepares a one-dimensional array nancestor(n). The one-dimensional array nancestor(n) stores parent nodes processed in the order of post-order. An initial value of the one-dimensional array nancestor(n) is i.

(Counting Procedure of a Column Count)

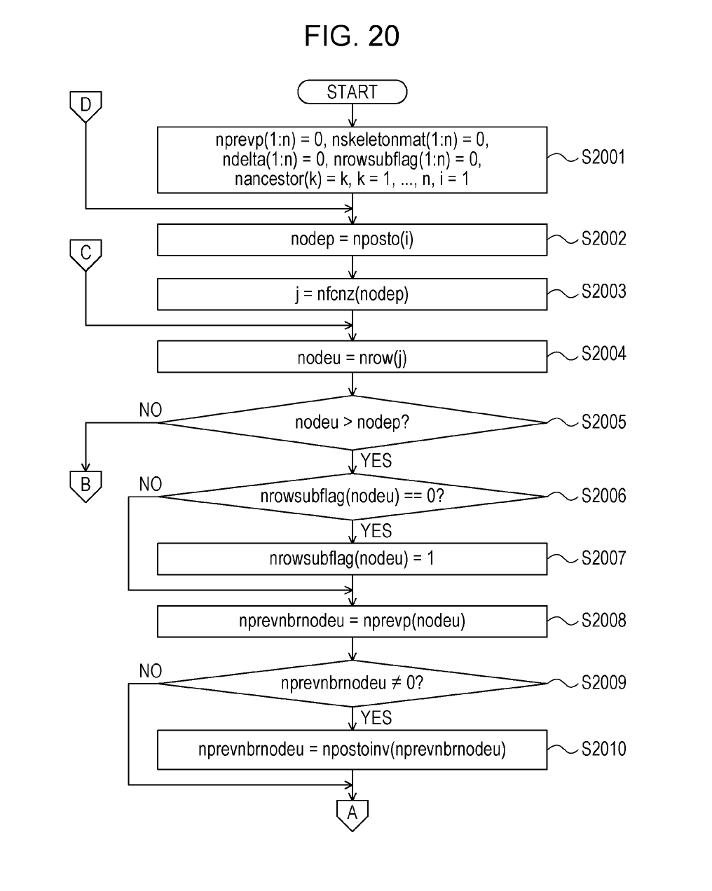

A counting procedure of a column count is described hereinafter with reference to FIGS. 20 to 22. In the description below, “a==b” indicates that a and b match. “a.ne.b” indicates that a and b do not match. “a=b” indicates that b is substituted to a. “a:b” indicates a to b.

FIGS. 20 to 22 are flow charts illustrating one example of the counting procedure of a column count. In FIG. 20, the information processing device 100 initializes an array (step S2001). For example, the information processing device 100 sets the one-dimensional array nprevp(1:n)=0, the one-dimensional array nskeletonmat(1:n)=0, the one-dimensional array ndelta(1:n)=0, and the one-dimensional array nrowsubflag(1:n)=0. The information processing device 100 also sets, for example, a one-dimensional array nancestor(k)=k, k=1, . . . , n,i=1.

Then, the information processing device 100 acquires an index of a node whose post-order is “i” as nodep=nposto(i) (step S2002). Then, the information processing device 100 sets j=nfcnz(nodep) (step S2003).

Then, the information processing device 100 sets nodeu=nrow(j) (step S2004). Then, the information processing device 100 determines whether or not nodeu>nodep (step S2005). Here, when nodeu>nodep is not true (step S2005: No), the information processing device 100 proceeds to a process in step S2106.

On the one hand, when nodeu>nodep (step S2005: Yes), the information processing device 100 determines whether or not nrowsubflag(nodeu)==0 (step S2006). Here, when nrowsubflag(nodeu)==0 is not true (step S2006: No), the information processing device 100 proceeds to a process in step S2008.

On the one hand, when nrowsubflag(nodeu)==0 (step S2006: Yes), the information processing device 100 sets nrowsubflag(nodeu)=1 (step S2007). Then, the information processing device 100 sets nprevnbrnodeu=nprevp(nodeu) (step S2008).

Then, the information processing device 100 determines whether or not nprevnbrnodeu≠0 (step S2009). Here, when nprevnbrnodeu≠0 is not true (step S2009: No), the information processing device 100 proceeds to a process in step S2101.

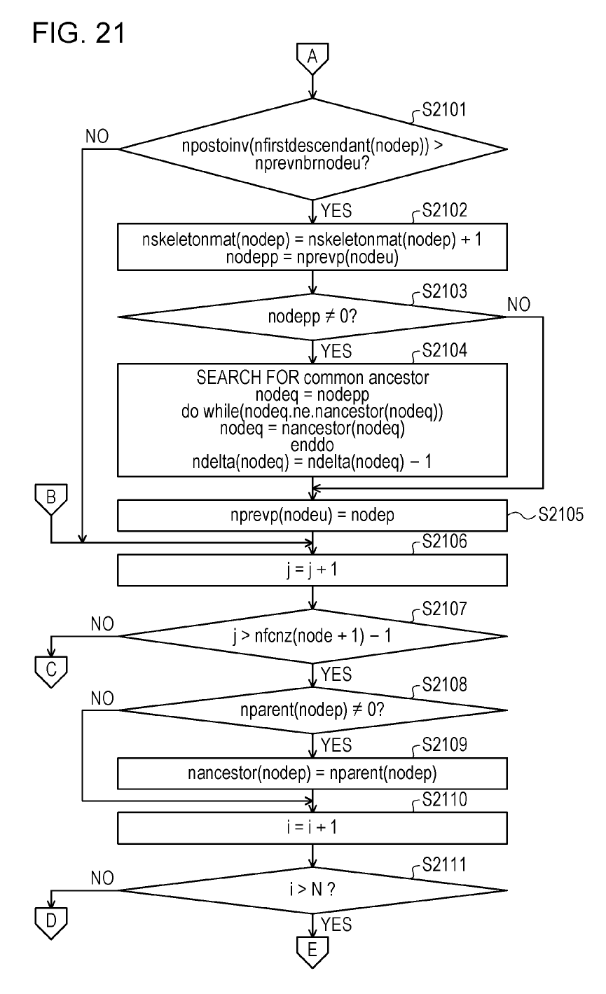

On the one hand, when nprevnbrnodeu≠0 (step S2009: Yes), the information processing device 100 acquires post-order of nprevnbrnodeu as nprevnbrnodeu=npostoinv (nprevnbrnodeu) (step S2010). Then, the information processing device 100 proceeds to a process in step S2101 of FIG. 21.

In FIG. 21, in order to check whether or not the node is a leaf node, the information processing device 100 determines whether or not npostoinv(nfirstdescendant(nodep))>nprevnbrnodeu (step S2101). Here, when npostoinv(nfirstdescendant(nodep))>nprevnbrnodeu is not true (step S2101: No), the information processing device 100 proceeds to a process in step S2106.

On the one hand, when npostoinv(nfirstdescendant(nodep))>nprevnbrnodeu (step S2101: Yes), the information processing device 100 proceeds to a process in step S2102. In step S2102, the information processing device 100 sets nskeletonmat(nodep)=nskeletonmat(nodep)+1 and nodepp=nprevp(nodeu) (step S2102).

Then, the information processing device 100 determines whether or not nodepp≠0 (step S2103). Here, when nodepp≠0 is not true (step S2103: No), the information processing device 100 proceeds to a process in step S2105.

On the one hand, when nodepp≠0 (step S2103: Yes), the information processing device 100 searches for a common ancestor, sets nodeq=nodepp, and nodeq=nancestor(nodeq). Then, the information processing device 100 repeats nodeq=nancestor(nodeq) till the condition (nodeq.ne.nancestor(nodeq)) is satisfied and sets ndelta(nodeq)=ndelta(nodeq)−1 (step S2104).

Next, the information processing device 100 sets nprevp(nodeu)=nodep (step S2105). Then, the information processing device 100 sets j=j+1 (step S2106). Then, the information processing device 100 determines whether or not j>nfcnz(node+1)−1 (step S2107). Here, when j>nfcnz(node+1)−1 is not true (step S2107: No), the information processing device 100 proceeds to a process in step S2004.

On the one hand, when j>nfcnz(node+1)−1 (step S2107: Yes), the information processing device 100 determines whether or not nparent(nodep)≠0 (step S2108). Here, when nparent(nodep)≠0 is not true (step S2108: No), the information processing device 100 proceeds to a process in step S2110.

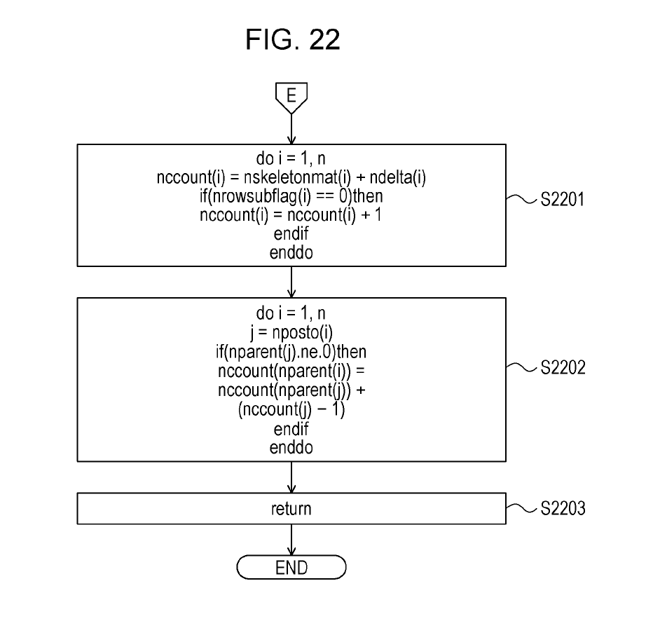

On the one hand, when nparent(nodep)≠0 (step S2108: Yes), the information processing device 100 sets nancestor(nodep)=nparent(nodep) (step S2109). Then, the information processing device 100 sets i=i+1 (step S2110). Then, the information processing device 100 determines whether or not i>N (step S2111). Here, when i>N is not true (step S2111: No), the information processing device 100 proceeds to a process in step S2002. On the one hand, when i>N (step S2111: Yes), the information processing device 100 proceeds to a process in step S2201 of FIG. 22.

In FIG. 22, the information processing device 100 sets nccount(i)=nskeletonmat(i)+ndelta(i). If nrowsubflag(i)==0, the information processing device 100 repeats a process of setting nccount(i)=nccount(i)+1 from i=1 to i=n (step S2201).

Then, the information processing device 100 sets j=nposto(i). If nparent(j).ne.0, the information processing device 100 repeats a process of setting nccount(nparent(i))=nccount(nparent(j))+(nccount(j)−1) from i=1 to i=n (step S2202).

Then, the information processing device 100 returns nccount(i) as a return value (step S2203), and finishes the counting process. This enables the information processing device 100 to cancel propagation from child nodes and to propagate a value of a characteristic function from one child node, when there are branching nodes in a row subtree. Then, the information processing device 100 may count a column count.

Here, searching of a common ancestor of two nodes by the information processing device 100 is described. The information processing device 100 sets information indicating an ancestor of each node to nancestor, for example. The information processing device 100 initializes each node itself as an ancestor. The information processing device 100 retrieves a node i in the order of post-order, and sets ancestor(i) of the node i=nparent(i). The information processing device 100 determines for a row number r of a non-zero element present in a column related to the node i whether or not the node i is a leaf node of a row subtree corresponding to the r^{th} row.

The information processing device 100 stores a leaf node u before a node r in nprevp(r). If the node i is a leaf node, the information processing device 100 sets a last node whose ancestor is not the node i when the ancestor of the node u is traced, as a node ica of a common ancestor.

As described above, with the information processing device 100, the number of non-zero elements of a lower triangular matrix L(A) or an upper triangular matrix U(A) obtained by LU factorizing a sparse matrix A may be calculated, from an elimination tree 1401 of a symmetric matrix P, which is obtained by symmetrizing the sparse matrix A. This enables the information processing device 100 to reduce a size of an area to store a result of LU factorization of the sparse matrix A, and to easily reserve the area to store a result of LU factorization even when the sparse matrix A increases in size. The information processing device 100 may also omit any operation that does not have to be done in LU factorization, and efficiently LU factorize the sparse matrix A.

In addition, with the information processing device 100, an elimination tree 1401 may be generated from elements located mutually symmetric positions of the sparse matrix A without generating a symmetric matrix P from the sparse matrix A. This enables the information processing device 100 to simplify operation involved in generation of the elimination tree 1401, and to efficiently generate the elimination tree 1401.

In addition, with the information processing device 100, an area to store a result of LU factorization of the sparse matrix A may be calculated using a supernode. This enables the information processing device 100 to reduce the size of the area to store a result of LU factorization of the sparse matrix A.

Note that the information processing method described in this embodiment may be performed by executing a program prepared in advance with a computer such as a personal computer and a workstation. This information processing program described in FIG. 18 or FIGS. 19 to 22 is recorded in a non-transitory and computer-readable recording medium such as a hard disk, a flexible disk, a CD-ROM, an MO and a DVD, and executed by being read by the computer from the recording medium. In addition, this information processing program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a control unit configured to
generate from a complex asymmetric sparse matrix an elimination tree of a symmetric matrix of the complex asymmetric sparse matrix,
based on the generated elimination tree, extract a row subtree of each of rows of a lower triangular matrix of the complex asymmetric sparse matrix and a row subtree of each of rows of a transposed matrix of an upper triangular matrix of the complex asymmetric sparse matrix, and
determine an amount of memory area to store a result of LU factorization of the complex asymmetric sparse matrix, based on the number of row subtrees including nodes of the elimination tree, of the extracted row subtrees of the rows of the lower triangular matrix, and the number of row subtrees including nodes of the elimination tree, of the extracted row subtrees of the rows of the transposed matrix of the upper triangular matrix.

2. The information processing device according to claim 1, wherein the control unit generates the elimination tree of the symmetric matrix from a combination of elements located at symmetric positions of the complex asymmetric sparse matrix.

3. The information processing device according to claim 1, wherein the control unit determines the amount of memory area to store the result of LU factorization of the complex asymmetric sparse matrix, based on a supernode that is a collection of a plurality of columns or rows with a common pattern of non-zero elements in the result of LU factorization of the symmetric matrix.

4. An information processing method executed by a computer, the method comprising processes of
generating from a complex asymmetric sparse matrix an elimination tree of a symmetric matrix of the complex asymmetric sparse matrix,
based on the generated elimination tree, extracting a row subtree of each of rows of a lower triangular matrix of the complex asymmetric sparse matrix and a row subtree of each of rows of a transposed matrix of an upper triangular matrix of the complex asymmetric sparse matrix, and
determining an amount of memory area to store a result of LU factorization of the complex asymmetric sparse matrix, based on the number of row subtrees including nodes of the elimination tree, of the extracted row subtrees of the rows of the lower triangular matrix, and the number of row subtrees including nodes of the elimination tree, of the extracted row subtrees of the rows of the transposed matrix of the upper triangular matrix.

5. A non-transitory and computer-readable recording medium storing a program which causes a computer to perform processes of
generating from a complex asymmetric sparse matrix an elimination tree of a symmetric matrix of the complex asymmetric sparse matrix,
based on the generated elimination tree, extracting a row subtree of each of rows of a lower triangular matrix of the complex asymmetric sparse matrix and a row subtree of each of rows of a transposed matrix of an upper triangular matrix of the complex asymmetric sparse matrix, and
determining an amount of memory area to store a result of LU factorization of the complex asymmetric sparse matrix, based on the number of row subtrees including nodes of the elimination tree, of the extracted row subtrees of the rows of the lower triangular matrix, and the number of row subtrees including nodes of the elimination tree, of the extracted row subtrees of the rows of the transposed matrix of the upper triangular matrix.
